(19) United States
(12) Patent Application Publication
(10) Pub. No.: US 2009/0220879 A1
(43) Pub. Date: Sep. 3, 2009

(54) TONER FOR DEVELOPING LATENT ELECTROSTATIC IMAGE, IMAGE FORMING DEVICE AND PROCESS CARTRIDGE USING THE SAME

(76) Inventors: Mitsuyo MATSUMOTO, Osaka (JP); Chiyoshi Nozaki, Otsu-shi (JP); Takuya Kadota, Kobe-shi (JP); Katsunori Kurose, Takarazuka-shi (JP); Tsuyoshi Nozaki, Osaka (JP); Atsushi Yamamoto, Kawanishi-shi (JP); Yoshimichi Ishikawa, Itami-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/389,823

(22) Filed: Feb. 20, 2009

(30) Foreign Application Priority Data
Feb. 29, 2008 (JP) 2008-049589
Dec. 12, 2008 (JP) 2008-316589

(51) Int. Cl. G03G 9/00; G03G 21/18; G03G 15/08

(52) U.S. Cl. 430/108.1; 399/111; 430/111.4; 430/108.8; 399/252

(57) ABSTRACT

Provision of a toner for developing a latent electrostatic image, including a colorant, a binder resin, and a releasing agent, where molecular weight distribution of THF-soluble components of the toner measured by a GPC is in the range of Mw 4,000 to Mw 11,000, and a peak area of low molecular weight components having a molecular weight of 200 to 500 is 3.2% or less based on the whole peak area.

### BACKGROUND OF THE INVENTION

1. Field of the Invention

The present invention relates to a toner for developing a latent electrostatic image for use in a copier or a printer utilizing electrophotography, and an image forming device and a process cartridge using the toner.

2. Description of the Related Art

An electrophotographic image forming process is generally a process in which an electrostatic image formed by various means is developed with a developer on a photoconductor made of a photoconductive substance, and the developed image is transferred to paper or the like at need, and the transferred developed image is fixed by using heat, pressure, solvent vapor, or the like.

Methods of developing an electrostatic image can be broadly divided into two categories; a liquid development which utilizes a developer liquid in which various pigments and dyes are dispersed in an insulating organic liquid; and a dry development, such as a cascade development, magnetic brush development and a powder cloud development, which utilizes a dry developer (hereinafter, may be referred to as a “toner”) in which a colorant such as a carbon black is dispersed in a natural or synthetic resin. In recent years, the dry development has been widely used.

As a fixation method for the dry development, the thermal roll method is commonly used in view of energy efficiency. Recently, for energy saving by a low temperature fixability of a toner, the thermal energy given to the toner for the fixation tends to be reduced. In the Demand-side Management (DSM) program in 1999 of the International Energy Agency (IEA), there is a technology procurement project regarding a next-generation copier, and the specification therefor is published. The specification requires a dramatic achievement of energy saving compared to the conventional copier, specifying that, for a copier of 30 cpm or higher, standby time be 10 seconds or less, and electric power consumption during the standby time be 10 W to 30 W, which should vary depending on the copier used. One of the approaches to meet the requirements may be to lower a heat capacity of the fixing member of the thermal roller or the like and to enhance the temperature response of a toner. Such a method, however, is unsatisfactory.

In order to satisfy the requirements by minimizing the standby time, it is considered that the lowering of the fixation temperature of a toner should be an essential technical object. To achieve the low temperature fixability, a polyester resin, which is excellent in low temperature fixability and is relatively excellent in heat resistance and storage stability, has been used in place of a commonly-used styrene-acrylic resin.

Alternative methods to improve the low temperature fixability include a method using a specific non-olefin crystalline polymer as a binder resin and a method using crystalline polyester as a binder resin. In the methods, however, the molecular structure and the molecular weight do not seem to be optimized. Even if the method is applied, the requirement in the DSM program cannot be met.

Methods for producing a toner for developing a latent electrostatic image are broadly divided into a pulverizing method and a polymerizing method. In the pulverizing method, a toner is produced in the process including melt-mixing a colorant, an antistatic agent, an offset resistance agent and the like and homogeneously dispersing the mixture in a thermoplastic resin, pulverizing the resultant composition, and classifying the pulverized composition. Using the pulverizing method enables to produce the toner having a fairly excellent performance, but a selection of the material to be used for the toner is limited. The composition obtained by the melt-mixing has to be pulverized and classified using an economically acceptable apparatus. Accordingly, the composition obtained by the melt-mixing must be sufficiently fragile. Also, the particle size distribution tends to be too wide when the composition is pulverized. Under the situation, to obtain a copied image having a satisfactory definition and gradation, it is necessary to reduce the mass-average particle size of the toner. However, if fine particles having a particle diameter of 4 μm or less and coarse particles having a particle size diameter of 15 μm or greater are both removed through the classification, the yield of the toner would be lowered. In addition, in the pulverizing method, it is difficult to obtain a homogeneous dispersion of a colorant, antistatic agent, etc. in a thermoplastic resin. Inhomogeneous dispersion exerts a harmful influence upon flowability, developability, durability, image quality, etc.

The polymerization method is known to be a method free from such drawbacks as in the pulverizing method. Examples of the polymerization method include suspension polymerization method and emulsion polymerization-aggregation method (see Japanese Patent (JP-B) No. 2537503).

However, it is impossible in the method to produce the toner from a polyester resin. To overcome the problem, a toner in which a toner particle made of polyester resin is made to a spherical particle using an organic solvent (see Japanese Patent Application Laid-Open (JP-A) No. 09-34167), and a toner obtained by reacting a prepolymer having an isocyanate group with amines (see Japanese Patent Application Laid-Open (JP-A) No. 11-149180) are proposed. However, such toners are insufficient in fixability at a low temperature, so that the energy required for fixation tends to increase. This problem is particularly serious in producing a full-color toner.

In view of the above problems, a toner is proposed which is prepared by dissolving or dispersing, in an organic solvent, a toner composition containing polyester resin and a polymer having a functional group which is capable of reacting with an active hydrogen-containing group; dispersing the resultant solution or dispersion liquid in an aqueous medium; and reacting the polymer having a functional group which is capable of reacting with an active hydrogen-containing group and a compound having an active hydrogen.

However, a color printer has been downsized, and even if the toner is used, the heat and stress due to the increase of printing speed tends to cause the waxy component and impurities of the resin to bleed, leading to the occurrence of sticking. This problem arises also in the case of a toner having little wax on the surface. Thus it was necessary to remove any sticking material other than wax.

Although a toner containing a little amount of a low molecular component resulted from polyester resin (Japanese Patent Application Laid-Open (JP-A) No. 2005-148726) is disclosed, the remove of the sticking material remains insufficient.

### BRIEF SUMMARY OF THE INVENTION

In view of the above-mentioned problems in the conventional techniques, an object of the present invention is to provide a toner for developing a latent electrostatic image, the toner being excellent in low temperature fixability and sticking resistance.

As mentioned above, there is a problem that the waxy component and impurities of the resin often bleed, causing the sticking. The problem was particularly serious in using a toner prepared by dissolving or dispersing, in an organic solvent, a toner composition containing polyester resin and a polymer having a functional group which is capable of reacting with an active hydrogen-containing group; dispersing the resultant solution or dispersion liquid in an aqueous medium; and reacting the polymer having a functional group which is capable of reacting with an active hydrogen-containing group and a compound having an active hydrogen. This problem arises also in the case of a toner having little wax on the surface. Thus it was necessary to remove any sticking material other than wax. After extensive studies, the present inventors have found that the sticking material other than wax is low molecular weight components having a molecular weight of 200 to 500 in the molecular weight distribution of tetrahydrofuran (THF)-soluble components through a Gel Permeation Chromatography (GPC), and have concluded that the problems can be solved by the heat treatment to specify that the molecular weight distribution of THF-soluble components of the toner measured by a GPC be in the range of Mw 4,000 to 11,000, and peak area of low molecular weight components having a molecular weight of 200 to 500 be 3.2% or less based on the whole peak area. The present invention has been accomplished by the findings.

Means for Solving the Problem is as Follows:

<1> A toner for developing a latent electrostatic image, including:

a colorant,

a binder resin, and

a releasing agent,

wherein molecular weight distribution of THF-soluble components of the toner measured by a GPC is in the range of Mw 4,000 to Mw 11,000, and a peak area of low molecular weight components having a molecular weight of 200 to 500 is 3.2% or less based on the whole peak area.
<2> The toner for developing a latent electrostatic image according to <1>, wherein the toner has a glass transition temperature of 40° C. or higher.
<3> The toner for developing a latent electrostatic image according to any one of <1> and <2>, wherein the toner has a volume-average particle diameter of 4.5 μm to 8 μm.
<4> The toner for developing a latent electrostatic image according to any one of <1> to <3>, wherein the releasing agent includes at least one of a polyolefin wax, a long chain hydrocarbon, or a carbonyl group-containing wax.
<5> The toner for developing a latent electrostatic image according to any one of <1> to <4>, which is obtainable by the process including:

dissolving or dispersing, at least, a polyester resin, a polymer having a site capable of reacting with a compound having an active hydrogen-containing group, an active hydrogen-containing compound, a releasing agent, and a colorant in an organic solvent to obtain a solution or dispersion liquid;

dispersing the solution or dispersion liquid into an aqueous solvent; and

subjecting the polymer having a site capable of reacting with a compound having an active hydrogen-containing group and the compound having an active hydrogen-containing group to a cross-linking reaction or an elongation reaction.

<6> The toner for developing a latent electrostatic image according to <5>, wherein, in the organic solvent, an inorganic mineral having a layered structure in which at least a part of the ions present between the layers are modified with organic ions is dissolved or dispersed.
<7> The toner for developing a latent electrostatic image according to any one of <5> or <6>, wherein the polymer having a site capable of reacting with a compound having an active hydrogen-containing group is a modified polyester prepolymer having an isocyanate group at a terminal thereof, and the active hydrogen-containing compound is an amine.
<8> The toner for developing a latent electrostatic image according to any one of <1> to <7>, wherein the toner is a toner for developing a non-magnetized one component.
<9> An image forming device including:
the toner for developing a latent electrostatic image according to any one of <1> to <8>; and a container main body in which the toner is housed.
<10> A container in which the toner for developing a latent electrostatic image according to any one of <1> to <8> is housed.
<11> A process cartridge including at least:

a latent image carrier configured to form a latent image thereon; and

a developing device configured to develop the latent image formed on the latent image carrier with a toner,

wherein the latent image carrier and the developing device are mounted as one body, and the process cartridge is detachably mounted to an image forming device, and

wherein the toner is a toner for developing a latent electrostatic image according to any one of <1> to <8>.

The present invention provides a toner excellent in low temperature fixability and offset resistance, and also provides a tone excellent in antisticking property by lowering the amount of the low molecular weight components. Preferably, the toner can be obtained by the process including dissolving or dispersing, at least, a polyester resin, a polymer having a site capable of reacting with a compound having an active hydrogen-containing group, an active hydrogen-containing compound, a releasing agent, and a colorant in an organic solvent to obtain a solution or dispersion liquid; dispersing the solution or dispersion liquid into an aqueous solvent; and subjecting the polymer having a site capable of reacting with a compound having an active hydrogen-containing group and the compound having an active hydrogen-containing group to a cross-linking reaction or an elongation reaction.

### BRIEF DESCRIPTION OF THE DRAWINGS

FIG. 1 shows a schematic cross-sectional view of one example of the image forming apparatus of the present invention.

FIG. 2 shows a schematic cross-sectional view of the developing part of the image forming apparatus of the present invention.

FIG. 3 shows a schematic cross-sectional view of one example of the process cartridge of the present invention.

FIG. 4 shows the GPC chart of the THF-soluble components of the toner obtained in Example 1.

FIG. 5 shows the GPC chart of the THF-soluble components of the toner obtained in Comparative Example 1.

FIG. 6 shows a schematic view of the fixing apparatus used in the evaluation of separation of the fixation.

FIG. 7 shows a schematic view of the fixing device used in the evaluation of the fixability.

### DETAILED DESCRIPTION OF THE INVENTION

Hereinafter, the toner of the present invention will be explained in more detail.

The toner of the present invention is a toner for developing a latent electostatic image in which molecular weight distribution of THF-soluble components of the toner measured by a GPC is in the range of Mw 4,000 to Mw 11,000, and peak area of low molecular weight components having a molecular weight of 200 to 500 is 3.2% or less based on the whole peak area. Preferably, the toner of the present invention is the toner for developing a latent electrostatic image, which is obtainable by the process including: dissolving or dispersing, at least, a polyester resin, a polymer having a site capable of reacting with a compound having an active hydrogen-containing group, an active hydrogen-containing compound, a releasing agent, and a colorant in an organic solvent to obtain a solution or dispersion liquid; dispersing the solution or dispersion liquid into an aqueous solvent; and subjecting the polymer having a site capable of reacting with a compound having an active hydrogen-containing group and the compound having an active hydrogen-containing group to a cross-linking reaction or an elongation reaction.

To overcome the problem that heat or stress due to the increase of printing speed causes the bleeding of wax components and impurities of resins, which then causes sticking to occur, it is necessary that the sticking matter other than waxes are low molecular weight components having a molecular weight of 200 to 500 in a molecular weight distribution of THF-soluble components measured by a GPC, and the peak area of the low molecular weight components is 3.2% or less based on the whole peak area, in order to increase anti-sticking effect. If the peak area exceeds 3.2%, no anti-sticking effect can be observed.

Preferably, the peak area of the components having a molecular weight of 200 to 500 is 3.0% or less on the whole peak area.

As to a method to confine the peak area of components having a molecular weight of 200 to 500 in the molecular weight distribution of THF-soluble components of the toner to 3.2% or less, in producing toner particles in the aqueous medium, it is preferable to take a process which include granulating the toner particles in an aqueous medium; isolating the granulated toner particles from the aqueous medium (first solid-liquid separation step); dispersing again the particles in another aqueous medium; isolating the re-dispersed particles (second solid-liquid separation step); and heating the dispersion liquid to the glass transition temperature or more of the toner. By heating the dispersion liquid to the glass transition temperature or more of the toner, the low molecular components can be removed, and the peak area can be 3.2% or less of the whole peak area. The reason therefor is considered as follows: Heating the toner particles up to the glass transition temperature or more causes the particles to perform micro-Brownian motion which enables to cause matter exchange inside the toner, and by matter exchange, high polar low molecular weight components in the toner tend to migrate to an aqueous medium.

The toner of the present invention may be produced not only by the above-mentioned method in which toner particles are prepared in an aqueous medium, but also by pulverizing method. In the latter method, toner bases are first obtained by granulating a mixture of a colorant, a binder resin and a releasing agent, and subsequently the toner bases are dispersed in an aqueous medium, and the dispersion liquid is heated to or over the glass transition temperature of the toner to be obtained in order to remove the low molecular weight components, so that the peak area is 3.2% or less on the whole peak area.

By specifying the molecular weight distribution of THF-soluble components of the toner measured by a GPC to be in the range of Mw 4,000 to Mw 11,000, a toner excellent in low temperature fixability and in offset resistance is obtained. Preferable range of the molecular weight is Mw 4,500 to Mw 10,000, more preferably Mw 5,000 to Mw 8,000.

The molecular weight distribution of the toner by a GPC can be regulated by changing the molecular weight of the binder resin to be used and a composition thereof. In a toner for developing a latent electrostatic image obtained by the process including dissolving or dispersing, at least, a polyester resin, a polymer having a site capable of reacting with a compound having an active hydrogen-containing group, an active hydrogen-containing compound, a releasing agent, and a colorant in an organic solvent to obtain a solution or dispersion liquid, dispersing the solution or dispersion liquid into an aqueous solvent, and subjecting the polymer having a site capable of reacting with a compound having an active hydrogen-containing group and the compound having an active hydrogen-containing group to a cross-linking reaction or an elongation reaction, the molecular weight distribution of the toner by a GPC can be regulated by changing the mixing ratio of the polyester resin to the polymer having a functional group capable of reacting with the active hydrogen-containing group.

The toner of the present invention preferably has a volume average particle diameter (Dv) of 4.5 μm to 8 μm. In general, a toner particle having a diameter as small as possible is advantageous in obtaining a high resolution and a high quality image. However, such small particles are disadvantageous in transfer property and cleaning property. In addition, if the volume average particle diameter is smaller than 4.5 μm, when used in a two-component developer, a toner is melted and adhered to the surface of a carrier by stirring over a long term in a developing device, lowering the charging capacity of the carrier, or when used in a single component developer, the filming of a toner to a developing roller or melting and adhering of a toner to a member such as a blade used for thinning the toner is likely to occur.

In the present invention, the glass transition temperature is preferably 40° C. or more to secure heat-resistance and storage stability of the toner.

### <A Method of Producing a Toner>

A toner is obtained by the addition, if necessary, of an external additive to a coloring particle (toner base).

A method to obtain a coloring particle may be a conventional method. Examples of the methods include knead-pulverizing method, dissolution-suspension method, and ester-elongation method. Of these, the knead-pulverizing method and the ester-elongation method are preferable. Next, the knead-pulverizing method and ester-elongation method will be explained in detail.

### <<Pulverizing Method>>

The pulverizing method, for example, is the method in which a toner composition containing at least a charge controlling agent and a colorant is mixed mechanically, and the mixture is melted and kneaded, and the kneaded product is crushed and classified to produce the toner. By-products produced in the mixing and melt-kneading may be reused.

The mechanical mixing can be performed under ordinary conditions using a mixer equipped with stirring blades, but is not limited thereto. After completion of the step, the resultant mixture is placed into a melt-kneader and melted and kneaded. For the melt-kneader, it is possible to use a uniaxial or biaxial continuous kneader, and a batch kneader using a roll mill. For example, a KTK biaxial extruder produced by Kobe Steel Ltd., a TEM extruder produced by Toshiba Machine Co., Ltd., a biaxial extruder produced by KCK, a PCM biaxial extruder produced by Ikegai Ltd., and a co-kneader produced by Buss are preferably used. The melt-kneading is preferably performed under a condition that does not bring about separation of molecular chain of the binder resin. When the melt-kneading temperature is excessively lower than the softening point of the binder resin, molecular chains are cleaved, whereas the melt-kneading temperature is excessively higher than the softening point, the dispersion of charge controlling agent and a colorant may not proceed. Accordingly, the melt-kneading temperature is preferably adjusted referring to the softening point of the binder resin.

After the melt-kneading, the kneaded product is pulverized. In the pulverization, it is preferable that the obtained kneaded product be coarsely crushed and then finely pulverized. Examples of the pulverizing method include a method in which a kneaded product is made collided with a collision plate in a jet stream, a method in which particles are made collided with each other in a jet stream, and a method in which a kneaded product is pulverized in a gap between a mechanically rotating roller and a stirrer. After the pulverization is completed, the pulverized product is classified in an air stream using a centrifuge or the like, to thereby obtain toner particles having predetermined particle diameters.

In a heating process, the particles are dispersed in an ion exchange water at about 40° C. It is preferable when dispersing the particles to heat the particles to the glass transition temperature or more. When the heating, a surfactant may be used in order to disperse the particles. The resultant particles are subjected to heating and drying treatments in the same manner as in the ester elongation method, to thereby obtain the toner particles.

### (Binder Resin)

The binder resin is not particularly limited. Known binder resins in the field of full-color toners such as polyester resins, (meth)acrylic resins, a styrene-(meth)acrylic copolymer resin, epoxy resins, cyclic olefin resins (COC e.g. TOPAS-COC produced by Ticona). The polyester resins are preferably used from the viewpoint of oilless fixation.

The polyester resins used preferably in the present invention may be those obtained through polycondensation of polyhydric alcohol component and polyvalent carboxylic acid component may be used.

Examples of dihydric alcohol component included in the polyvalent alcohol component include bisphenol A-alkylene oxide adducts such as polyoxypropylene (2,2)-2,2-bis(4-hydroxyphenyl) propane, polyoxypropylene (3,3)-2,2-bis(4-hydroxyphenyl) propane, polyoxypropylene (6)-2,2-bis(4-hydroxyphenyl) propane and polyoxyethylene (2,0)-2,2-bis(4-hydroxyphenyl) propane; ethylene glycol, diethylene glycol, triethylene glycol, 1,2-propylene glycol, 1,3-propylene glycol, 1,4-butandiol, neopentyl glycol, 1,4-butendiol, 1,5-pentanediol, 1,6-hexanediol, 1,4-cyclohexanedimethanol, dipropylene glycol, polyethylene glycol, polytetramethylene glycol, bisphenol A and hydrogenated bisphenol A. Examples of trihydric or more alcohol components include sorbitol, 1,2,3,6-hexanetetrol, 1,4-sorbitan, pentaerythritol, dipentaerythritol, tripentaerythritol, 1,2,4-butantriol, 1,2,5-pentantriol, glycerol, 2-methylpropanetriol, 2-methyl-1,2,4-butantriol, trimethyrolethane, trimethyrolpropane, and 1,3,5-trihydroxymethylbenzene.

Furthermore, examples of bivalent carboxylic acid component of polyvalent carboxylic acid components include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, isooctenyl succinic acid, n-octyl succinic acid, isooctyl succinic acid and anhydrides thereof or lower alkylesters thereof.

Examples of trivalent or more carboxylic acid components include 1,2,4-benzenetricarboxylic acid (trimellitic acid), 1,2,5-benzentricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra (methylenecarboxyl)methane, 1,2,7,8-octanetetracarboxylic acid, pyromellitic acid, enpol trimeric acid and anhydrides thereof or lower alkylesters thereof.

Furthermore, a resin (hereinafter may be referred to as “a vinyl polyester resin”) obtained by performing condensation polymerization for obtaining polyester resin and radical polymerization for obtaining vinyl resin simultaneously in a same container using a mixture of a basic monomer of polyester resin, basic monomer of vinyl resin and a monomer which reacts with the basic monomers of both resins may be also preferably used as a polyester resin. Meanwhile, the monomer which reacts with basic monomers of both resins is defined as a monomer which can be used for both reactions of condensation polymerization and radical polymerization. In other words, it is a monomer having a carboxyl group which is reactable in condensation polymerization and a vinyl group which is reactable in radical polymerization and examples of such monomer include fumaric acid, maleic acid, acrylic acid and methacrylic acid.

Examples of basic monomers of polyester resin include above-mentioned polyvalent alcohol components and polyvalent carboxylic acid components. Examples of basic monomers of vinyl resin include styrene or styrene derivatives including styrene, o-methylstyrene, m-methylstyrene, p-methylstyrene, α-methylstyrene, p-ethylstyrene, 2,4-dimethylstyrene, p-tert-butylstyrene and p-chlorstyrene; ethylene unsaturated monoolefins including ethylene, propylene, butylene and isobutylene; methacrylic acid alkylesters such as methyl methacrylate, n-propyl methacrylate, isopropyl methacrylate, n-butyl methacrylate, isobutyl methacrylate, t-butyl methacrylate, n-pentyl methacrylate, isopentyl methacrylate, neopentyl methacrylate, 3-(methyl)butyl methacrylate, hexyl methacrylate, octyl methacrylate, nonyl methacrylate, decyl methacrylate, undecyl methacrylate and dodecyl methacrylate; acrylic acid alkylesters such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate and dodecyl acrylate; and unsaturated carboxylic acids such as acrylic acid, methacrylic acid, itaconic acid and maleic acid; acrylonitrile, maleic acid ester, itaconic acid ester, vinyl chloride, vinyl acetate, benzoic acid vinyl, vinyl methyl ethyl ketone, vinyl hexyl ketone, vinyl methyl ether, vinyl ethyl ether and vinyl isobutyl ether. Examples of polymerization initiator which is used for initiating polymerization of basic monomers of vinyl resin include azo-based or diazo-based polymerization initiators such as 2,2′-azobis (2,4-dimethylvaleronitrile), 2,2′-azobisisobutylonitrile, 1,1′-azobis (cyclohexane-1-carbonitrile), 2,2′-azobis-4-methoxy-2,4-dimethylvaleronitrile and peroxide-based polymerization initiators such as benzoyl peroxide, dicumyl peroxide, methyl ethyl ketone peroxide, isopropyl peroxycarbonate and lauroyl peroxide.

Various polyester resins as described above are preferably used as binder resins and of these, parallel usage of a first binder resin and a second binder resin is preferable and effective for further improvement of stripping and offset resistance as a toner for oilless fixation.

A polyester resin obtained by condensation polymerization of above-mentioned polyvalent alcohol components and polyvalent carboxylic acid components and in particular, a polyester resin obtained by using bisphenol A-alkylene oxide adduct as a polyvalent alcohol component and terephthalic acid and fumaric acid as polyvalent carboxylic components is used as the first binder resin.

Particularly, a vinyl polyester resin in which bisphenol A-alkylene oxide adduct, terephthalic acid, trimellitic acid and succinic acid are used as basic monomers of the polyester resin, styrene and butylacrylate are used as basic monomers of vinyl resin, and fumaric acid is used as a monomer which is reactable in both reactions, is used as the second binder resin.

### <<Ester Elongation Method>>

The toner of the present invention can also be obtained by the method, at least, including dissolving or dispersing, at least, a polyester resin, a polymer having a site capable of reacting with a compound having an active hydrogen-containing group, a releasing agent, and a colorant in an organic solvent to obtain a solution or dispersion liquid, dispersing the solution or dispersion liquid into an aqueous solvent, and granulating the resultant dispersion liquid.

Raw materials for use in the ester elongation method are as follows.

### <Layer Inorganic Minerals>

In the present invention, it is preferable to dissolve or disperse into the above-mentioned organic solvent a layer inorganic mineral in which at least part of ions present between layers is modified by organic ions.

The layer inorganic mineral is defined as an inorganic mineral consisting of layers each having a thickness of a few nanometers. The modification by organic ions means an introduction of organic ions into the ions present between the layers.

Examples of known layer inorganic minerals include minerals belonging to smectite group (e.g., montmorillonite, saponite), minerals belonging to kaolin group (e.g., kaolinite), magadiite, and kanemite. A modified layer inorganic mineral is highly hydrophilic due to the modified layer structure. If a layer inorganic mineral is used in the dispersion and granulation processes in toner production without any modification thereof, the layer inorganic mineral transfers into the aqueous medium so that toner particles cannot be deformed. Since a modified layer inorganic mineral is highly hydrophilic, it can readily be present on the surface of the toner when granulated, and the granulated product can be dispersed to fine particles, and the particles are deformed, and further the deformed particles can sufficiently achieve charge control function. The amount of the modified layer inorganic minerals is preferably 0.05% by mass to 2% by mass.

The modified layer inorganic minerals used in the present invention are preferably those having a smectite basic crystal structure modified by organic cations. A metallic anion can be introduced by replacing part of bivalent metals of the layer inorganic mineral with trivalent metals. However, since the introduction of metallic anion increases hydrophilicity, it is preferable to modify part of the metallic anion with an organic anion.

Examples of a modifier of the organic ion for use in modifying at least part of the ions present between the layers of the layer inorganic minerals include a quaternary alkyl ammonium salt, a phosphonium salt, and an imidazolium salt, of which a quaternary alkyl ammonium salt is preferred. Examples of the quaternary alkyl ammonium salt include trimethylstearyl ammonium, dimethylstearylbenzyl ammonium, dimethyloctadecylammonium, and, oleyl bis(2-hydroxyethyl)methyl ammonium.

Examples of the organic ion modifier include a sulfate, sulfonate, carboxylate or phosphate, each having a branched, linear or cyclic alkyl (C₁-C₄₄), alkenyl (C₁-C₂₂), alkoxy (C₈-C₃₂), hydroxyalkyl (C₂-C₂₂), ethylene oxide, or propylene oxide. Of these, a carboxylate having an ethylene oxide skeleton is preferred.

The partial modification of the layer inorganic mineral with an organic ion results in a modified layer inorganic mineral which have an appropriate hydrophobicity; provide an oil phase containing at least one of a toner composition and a toner composition precursor with non-Newtonian viscosity; and can deform the toner. Amount of the layer inorganic mineral modified partly with an organic ion in the toner materials is preferably 0.05% by mass to 2% by mass.

The layer inorganic mineral, which is to be partly modified with an organic ion, may be selected appropriately. Examples thereof include montmorillonite, bentonite, hectolite, attapulgite, sepiolite, and a mixture thereof. It is preferable to use montmorillonite or bentonite because they do not affect the toner performance; viscosity can easily be controlled; and amount to be added can be small.

Examples of commercially available layer inorganic minerals partly modified with organic cations include a quaternium 18 bentonite such as BENTONE 3, BENTONE 38, and BENTONE 38V (all produced by Leox Corp.) THIXOGEL VP (produced by United Catalyst Corp.), CLAYTON 34, CLAYTON 40 and CLAYTON XL (all produced by Southern Clay Products, Inc.); a stearalconium bentonite such as BENTONE 27 (produced by Leox Corp.), THIXOGEL LG (produced by United Catalyst Corp.), CLAYTON AF, CLAYTON APA (all produced by Southern Clay Products, Inc.); a quaternium 18/benzalconium bentonite such as CLAYTON HT and CLAYTON PS (all produced by Southern Clay Products, Inc.). CLAYTON AF and CLAYTON APA is preferable.

Preferable layer inorganic minerals partly modified with organic anions is DHT-4A (produced by Kyowa Chemical Industry Co., Ltd.) modified with an organic anion represented by the following General Formula (I).

R₁(OR₂)ₙOSO₃M (General Formula (1))

In General Formula (I), R₁ represents an alkyl group having 13 carbon atoms, R₂ represents an alkylene group having 2-6 carbon atoms, n is an integer of 2 to 10, and M is a univalent metallic element.

Preferable example of the compound of General Formula (I) include HITENOL 330T (produced by Dai-ichi Kogyo Seiyaku Co., Ltd.).

By using a modified layer inorganic mineral, the toner particles can maintain appropriately hydrophobicity, can easily move to the surface of liquid drop, and can unevenly be distributed on the surface, to thereby can charge the surface.

### <Polyester Resin>

The polyester resin used in the present invention is not limited, and any polyester resin may be used. A few types of polyester resins may be used in combination. The polyester resin may be, for example, a polycondensation product of polyol (1) and polycarboxylic acid (2) as illustrated below. It is preferable to use a non-modified polyester resin having an aromatic group-containing polyester skeleton in which an aromatic polycarboxylic acid is used as a polycarboxylic acid.

### (Polyol)

Examples of the polyol (1) include alkylene glycols (such as ethylene glycol, 1,2-propylene glycol, 1,3-propylene glycol, 1,4-butanediol, and 1,6-hexanediol); alkylene ether glycols (such as diethylene glycol, triethylene glycol, dipropylene glycol, polyethylene glycol, polypropylene glycol, and polytetramethylene ether glycol); alicyclic diols (such as 1,4-cyclohexane dimethanol and hydrogenated bisphenol A); bisphenols (such as bisphenol A, bisphenol F, bisphenol S, 3,3′-difluoro-4,4′-dihydroxybiphenyl, and other such 4,4′-dihydroxyphenyls); bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also known as tetrafluorobisphenol A), 2,2-bis(3-hydroxyphenyl)-1,1,1,3,3,3-hexafluoropropane), and other such bis(hydroxyphenyl) alkanes; bis(3-fluoro-4-hydroxyphenyl)ether and other such bis(4-hydroxyphenyl)ethers; adducts of the above-mentioned alicyclic diols with an alkylene oxide (such as ethylene oxide, propylene oxide, or butylene oxide); and adducts of the above-mentioned bisphenols with an alkylene oxide (such as ethylene oxide, propylene oxide, or butylene oxide).

Of these, alkylene glycols having from 2 to 12 carbon atoms and adducts of a bisphenol with an alkylene oxide are preferable. Adducts of a bisphenol with an alkylene oxide, or a mixture of such an adduct and an alkylene glycol having from 2 to 12 carbon atoms is more preferable.

Other examples include trihydric to octahydric or higher polyhydric aliphatic alcohols (such as glycerol, trimethylolethane, trimethylolpropane, pentaerythritol, and sorbitol); trihydric and higher phenols (such as trisphenol PA, phenol novolac, and cresol novolac); and adducts of the above-mentioned trihydric or higher polyphenols mentioned with an alkylene oxide.

These polyols can be used singly or in combination of two or more, and are not limited to what is listed above.

### (Polycarboxylic Acid)

Examples of the polycarboxylic acid (2) include alkylene dicarboxylic acids (such as succinic acid, adipic acid, and sebacic acid), alkenylene dicarboxylic acids (such as maleic acid and fumaric acid), and aromatic dicarboxylic acids (such as phthalic acid, isophthalic acid, terephthalic acid, naphthalene dicarboxylic acid, 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid, and hexafluoroisopropylidene diphthalic anhydride).

Of these, an alkenylene dicarboxylic acid having 4 to 20 carbon atoms, and an aromatic dicarboxylic acid having 8 to 20 carbon atoms are preferred. An aromatic polycarboxylic acid having 9 to 20 carbon atoms (such as trimellitic acid or pyromellitic acid), or an acid anhydride or a lower alkyl ester (such as a methyl ester, ethyl ester, or isopropyl ester) of the above, can be used as a trihydric or higher polycarboxylic acid to react with the polyol (1).

The above polycarboxylic acids can be used singly or in combination of two or more, and are not limited to what is listed above.

### (Ratio of Polyol to Polycarboxylic Acid)

The ratio of the polyol (1) to the polycarboxylic acid (2), as the equivalence ratio OH/COOH of hydroxyl groups (OH) to carboxyl groups (COOH), is usually from 2/1 to 1/1, preferably from 1.5/1 to 1/1, and more preferably from 1.3/1 to 1.02/1.

### (Molecular Weight of Polyester Resin)

The peak molecular weight is preferably 1,000 to 30,000, more preferably 1,500 to 10,000, even more preferably 2,000 to 8,000. The molecular weight less than 1,000 cannot ensure heat resistance and storage stability, although the molecular weight exceeding 30,000 degrades low temperature fixability.

The weight average molecular weight is preferably 2,000 to 25,000, more preferably 2,500 to 15,000, even more preferably 3,000 to 8,000.

### <Modified Polyester Resin>

In the toner of the present invention, it is preferable to contain, as a binder resin, a resin obtained by crosslinking reaction or elongation reaction of a polymer having a site capable of reacting with a compound having an active hydrogen-containing group with the compound having an active hydrogen-containing group. In order to regulate a viscoelasticity to prevent the offset, it is preferable that the polymer having a site capable of reacting with a compound having an active hydrogen-containing group is a modified polyester prepolymer having an isocyanate group at the terminal; that the compound having an active hydrogen-containing group is an amine; and that the toner contains a urea-modified polyester resin. The urea-modified polyester may contain urethane bonds along with urea bonds. When preparing toner particles by the granulation, the presence of urea-modified polyester resin, which is prepared by crosslinking or elongation reaction, facilitates the incorporation of a modified polyester resin having relatively high molecular weight for regulating the viscoelasticity into the core portions of toner particles. Amount of the urea-modified polyester resin in the binder resin is preferably 20% by mass or less, more preferably 15% by mass or less, even more preferably 10% by mass or less. An amount exceeding 20% by mass degrades low temperature fixability.

### (Prepolymer)

The prepolymer having an isocyanate group is preferably obtained by reacting the polyester having an active hydrogen-containing group, which is a polycondensation product of the polyol (1) and the polycarboxylic acid (2), with polyisocyanate (3). Examples of an active hydrogen-containing group of the polyester include a hydroxy group (alcoholic hydroxy group and phenolic hydroxy group), amino group, carboxyl group, and mercapto group. Of these, an alcoholic hydroxy group is preferable.

### (Polyisocyanate)

Examples of the polyisocyanate (3) include aliphatic polyisocyanates (such as tetramethylene diisocyanate, hexamethylene diisocyanate and 2,6-diisocyanate methylcaproate); alicyclic polyisocyanates (such as isophorone diisocyanate and cyclohexylmethane diisocyanate); aromatic diisocyanates (such as tolylene diisocyanate and diphenylmethane diisocyanate); aromatic aliphatic diisocyanates (such as α,α,α′,α′-tetramethyl xylylene diisocyanate); isocyanurates; and blocked polyisocyanates in which the above polyisocyanates are blocked with a phenol derivative, an oxime, or a caprolactam. These can be used singly or in combination of two or more.

### (Ratio of Isocyanate Groups to Hydroxyl Groups)

The ratio of the polyisocyanate (3), as an equivalent ratio [NCO]/[OH] of isocyanate groups (NCO) to hydroxyl groups (OH) of the polyester having hydroxyl groups, is usually from 5/1 to 1/1, preferably from 4/1 to 1.2/1, and more preferably from 2.5/1 to 1.5/1. If the ratio [NCO]/[OH] is more than 5, the low temperature fixability of the toner degrades, but if the ratio is less than 1, the urea content in the modified polyester is so low that hot offset resistance is poor. The amount in which the constituent components of the polyisocyanate (3) are contained in the prepolymer (A) having an isocyanate group at its terminal is usually from 0.5% by mass to 40% by mass, preferably from 1% by mass to 30% by mass, and more preferably from 2% by mass to 20% by mass. If the amount is less than 0.5% by mass, offset resistance will degrade, and this is also disadvantageous in terms of the heat resistance and low temperature fixability of the toner. If the amount is more than 40% by mass, low temperature fixability will degrade.

### (Number of Isocyanate Groups in Prepolymer)

The number of isocyanate groups included per molecule of the prepolymer (A) having isocyanate groups is usually 1 or more, preferably from 1.5 to 3 on average, and more preferably from 1.8 to 2.5 on average. If the number is less than 1 per molecule, the molecular weight of the modified polyester will be lower after crosslinking and/or elongation, and offset resistance will degrade.

### (Crosslinking Agent and Elongation Agent)

An amine can be used as a crosslinking agent or elongation agent. Examples of the amine (B) include diamines (B1), trivalent or higher polyamines (B2), amino alcohols (B3), amino mercaptans (B4), amino acids (B5), and blocked amines (B6) in which the amines B1 to B5 are blocked.

Examples of the diamines (B1) include aromatic diamines (such as phenylenediamine, diethyltoluenediamine, 4,4′-diaminodiphenylmethane, tetrafluoro-p-xylylenediamine, and tetrafluoro-p-phenylenediamine,), alicyclic diamines (such as 4,4′-diamino-3,3′-dimethyldicyclohexylmethane, diaminocyclohexane, and isophoronediamine), and aliphatic diamines (such as ethylenediamine, tetramethylenediamine, hexamethylenediamine, dodecafluorohexylenediamine and tetracosafluorododecylene diamine).

Examples of the trivalent or higher polyamines (B2) include diethylenetriamine and triethylenetetramine.

Examples of the amino alcohols (B3) include ethanolamine, diethanolamine, and hydroxyethyl aniline.

Examples of the amino mercaptans (B4) include aminoethyl mercaptan and aminopropyl mercaptan.

Examples of the amino acids (B5) include aminopropionic acid and aminocaproic acid.

Examples of the blocked amines (B6) in which the amines (B1) to (B5) are blocked include ketimine compounds and oxazoline compounds obtained from one of the above amines (B1) to (B5) and a ketone (such as acetone, methyl ethyl ketone, or methyl isobutyl ketone).

### (Stopping Agent)

The molecular weight of the modified polyester resin upon completion of the reaction can be adjusted as necessary using a reaction stopping agent for at least one of crosslinking and elongation. Examples of the stopping agent include monoamines (such as diethylamine, dibutylamine, butylamine, and laurylamine) and blocked amines (ketimine compounds) obtained by blocking the above monoamines.

### (Ratio of Amino Groups to Isocyanate Groups)

The ratio of the amine (B), as an equivalent ratio [NCO]/[NHx] of isocyanate groups [NCO] in prepolymer (A) having isocyanate groups to amino groups [NHx] in the amines (B), is usually from 2/1 to ½, preferably from 1.5/1 to 1/1.5, and more preferably from 1.2/1 to 1/1.2. If [NCO]/[NHx] is more than 2 or less than ½, the molecular weight of urea-modified polyester is so low that hot offset resistance degrades.

### <Colorant>

Any known dyes and pigments can be used as colorants in the present invention. Examples include carbon black, Nigrosine dyes, black iron oxide, Naphthol Yellow S, Hansa Yellow (10G, 5G, and G), Cadmium Yellow, yellow iron oxide, loess, chrome yellow, titanium yellow, polyazo yellow, Oil Yellow, Hansa Yellow (GR, A, RN, and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, para-chloro-ortho-nitroaniline red, Lithol Fast Scarlet G, Brilliant Fast Scarlet, Brilliant Carmine BS, Permanent Red (F2R, F4R, FRL, FRLL, and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, polyazo red, Chrome Vermilion, Benzidine Orange, Perinone Orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures of these. The colorant content in the toner is usually from 1% by mass to 15% by mass, and preferably from 3% by mass to 10% by mass, with respect to the toner.

### <Producing Colorant Master Batch>

The colorant used in the present invention can also be compounded with a resin and used as a master batch. Examples of the binder resin kneaded along with the master batch or used in the manufacture of the master batch include the modified and unmodified polyester resins listed above, as well as styrene polymers and substituted styrene polymers (such as polystyrenes, poly-p-chlorostyrenes, and polyvinyltoluenes), styrene copolymers (such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleic acid ester copolymers), polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylic acid resins, rosins, modified rosins, terpene resins, aliphatic or alicyclic hydrocarbon resins, aromatic petroleum resins, chlorinated paraffins, and paraffin waxes. These resins can be used singly or in mixtures.

### <Master Batch Production Method>

The master batch can be obtained by mixing the master batch resin and the colorant and kneading the mixture under a high shearing force. An organic solvent can be used to increase the interaction between the colorant and the resin. What is known as a flushing method, in which an aqueous paste including a colorant and water is mixed and kneaded with a resin and an organic solvent so that the colorant migrates to the resin side, and the organic solvent and water are removed, can be used preferably because the colorant wet cake can be used directly, without having to be dried first. When mixing and kneading the components, it is preferable to use a high-shear dispersing device such as a triple roll mill.

### <Releasing Agent>

As a releasing agent used in the present invention, any known releasing agent can be used. Examples thereof include polyolefin waxes (such as polyethylene wax and polypropylene wax); long chain hydrocarbons (such as paraffin wax and Sasolwax); and carbonyl group-containing waxes. Examples of the carbonyl group-containing wax include polyalkanoic acid esters (such as carnauba wax, montan wax, trimethylolpropane tribehenate, pentaerythritol tetrabehenate, pentaerythritol diacetatedibehenate, glycerine tribehenate, 1,18-octadecanedioldistearate); polyalkanolesters (such as tristearyl trimerittate, distearyl malleate); polyalkanoic acid amides (such as ethylenediamine dibehenylamide); polyalkylamides (such as trimellitic acid tristearylamide); and dialkyl ketones (such as distearyl ketone). Of these carbonyl group-containing waxes, preferable is polyalkanoic acid esters.

An amount of wax in the toner is preferably 5% by mass to 15% by mass with respect to 100% by mass of the resin components. If the amount of wax is less than 5% by mass, wax cannot achieve the releasing effect, and sometimes cannot show offset resistance, either. If the amount is more than 15% by mass, since wax melts at a low temperature and so is susceptible to thermal energy and mechanical energy, wax tends to ooze out of the toner when stirring in the developing process, and the oozed wax tends to adhere to a toner controlling member of a latent electrostatic image bearing member, resulting in the occurrence of the image noise. A peak thermal absorption of wax measured by using differential scanning calorimeter (DSC) at an elevated temperature is in the rage of 65° C. to 115° C., where the low temperature fixation of the toner is possible. If the melting point is lower than 65° C., the flowability degrades, and if it is higher than 115° C., fixability degrades.

### <Charge Control Agent>

The toner of the present invention may contain if necessary a charge control agent. Any known charge control agent may be used for the toner of the present invention.

Examples thereof include nigrosine dye, triphenylmethane dye, chrome-containing metal complex dye, molybdic acid chelate pigment, rhodamine dye, alkoxy amine, quaternized ammonium salt (including fluorine-modified quaternized ammonium salt), alkylamide, simple phosphorus or compound thereof, simple tungsten or compound thereof, fluorine activator, metal salicylate and metal salt of salicylic derivative. Specific examples include Bontron 03, a nigrosine dye, Bontron P-51, a quaternized ammonium salt, Bontron S-34, a metal-containing azo dye, E-82, oxynaphthoic acid metal complex, E-84, salicylic acid metal complex and E-89, a phenol condensate produced by Orient Chemical Industries, Ltd.; TP-302 and TP-415, molybdic complex of quaternized ammonium salt produced by Hodogaya Chemical Co., Ltd.; Copycharge PSY VP2038 of a quaternized ammonium salt, Copyblue PR of a triphenylmethane derivative and Copycharge NEG VP2036 and NX VP434 of quaternized ammonium salt produced by Hoechst Co.; LRA-901 and LR-147, a boron complex produced by Japan Carlit Co., Ltd; copper phthalocyanine, perylene, quinacridone, azo pigment and high polymer compound having functional group such as sulfonate group, carboxyl group and quaternized ammonium salt.

### <External Additive>

### (Inorganic Fine Particles)

Inorganic fine particles may be used preferably as an external additive for augmenting the flowability, developing property, and chargeability of the colorant particles that are obtained. The primary particle diameter of these inorganic fine particles is preferably from 5 nm to 2 μm, and more preferably from 5 nm to 500 nm. The specific surface area as measured by BET method is preferably from 20 m²/g to 500 m²/g. The proportion in which these inorganic fine particles are used is preferably from 0.01% by mass to 5% by mass, and more preferably from 0.01% by mass to 2.0% by mass, with respect to the toner. Specific examples of inorganic fine particles include silica, alumina, titanium oxide, barium titanate, magnesium titanate, calcium titanate, strontium titanate, zinc oxide, tin oxide, quartz sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride.

### (Polymeric Fine Particles)

In addition, polymeric particles may be used, such as methacrylic ester or acrylic ester copolymers or polystyrene obtained by soap-free emulsion polymerization or dispersion polymerization; polycondensates of silicone, benzoguanamine, nylon, and the like; and polymer particles produced from thermosetting resins.

### (External Additive Surface Treatment)

Such fluidizers can be surface treated to make them hydrophobic, which prevents the flowability and charge properties from being adversely affected even under high humidity. Examples include silane coupling agents, silylation agents, silane coupling agents including a fluoroalkyl group, organic titanate-based coupling agents, aluminum-based coupling agents, silicone oils, and modified silicone oils.

### <Method of Producing the Toner>

The ester elongation process include at least dissolving or dispersing, in an organic solvent, at least polyester resin, a polymer having a site capable of reacting with a compound having an active hydrogen-containing group, a colorant, and a releasing agent, and dispersing in an aqueous medium the resultant solution or dispersion liquid.

Hereinafter, the method will be described in more detail.

### <Granulation Process>

### (Organic Solvent)

As the organic solvent to dissolve or disperse a polyester resin, a polymer having a site capable of reacting with a compound having an active hydrogen-containing group, a colorant, and a releasing agent, it is preferable to use any of those recited in “POLYMER HANDBOOK,” 4th edition, WILEY INTERSCIENCE, vol. 2, sec VII, having Hansen solubility parameter of 19.5 or less. Preferably, the organic solvent is a volatile material having a boiling point less than 100° C., since such solvent can easily be removed in a later step. Examples thereof include toluen, xylene, benzen, carbon tetrachloride, methylene chloride, 1,2-dichloroethane, 1,1,2-trichloroethane, trichloroethylene, chloroform, monochlorobenzen, dichloroethylidene, methyl acetate, ethyl acetate, methylethylketone, and methylisobutylketone. These solvents may be used singly or in combination of two or more. Of these, preferred are esters such as methyl acetate and ethyl acetate; aromatic solvents such as toluene and xylene; halogenated hydrocarbons such as 1,2-dichloroethane, chloroform and carbon tetrachloride. The polyester resin, colorant and releasing agent may be dissolved or dispersed in an organic solvent concurrently or individually. When each component is dissolved or dispersed individually, the organic solvents to be used may be the same or different, but are preferably the same because of easiness of solvent removal at a later stage.

### (Dissolution or Dispersion of the Polyester Resin)

As for the solution of dispersion liquid of the polyester resin, a resin concentration is preferably 40% by mass to 80% by mass. If the resin concentration exceeds 80% by mass, the dissolution or the dispersion is difficult, and viscosity is so high that the solution or dispersion liquid is difficult to handle. If the resin concentration is less than 40% by mass, the amount of the toner to be produced is small. When using a mixture of a binder resin having an aromatic group-containing skeleton and the modified polyester resin having an isocyanate group at the terminal, they may be mixed in the same solution or dispersion, or the solution or dispersion may be prepared separately, but in view of each solubility and viscosity, it is preferable to prepare the solution or dispersion liquid separately.

### (Dissolution or Dispersion of Colorant)

Colorants may be dissolved or dispersed solely, or may be mixed in the solution or dispersion liquid of the polyester resin. If necessary, a dispersion aid or the polyester resin may be added, or the master batch may be used.

### (Dissolution or Dispersion of the Releasing Agent)

When wax is dissolved or dispersed as the releasing agent, if the organic solvent which does not dissolve the wax is used, the wax is used as the dispersion liquid, and the dispersion liquid is made by general methods. That is, the organic solvent and the wax can be mixed and dispersed using a dispersing machine such as bead mill. When the organic solvent and the wax are mixed, then the mixture is heated up to a melting point of the wax, subsequently cooled with stirring and then dispersed by the dispersing machine such as bead mill, a dispersion time period is sometimes shortened. Multiple waxes may be mixed and used, and the dispersion aid or the polyester resin may be added.

### (Aqueous Medium)

Water alone can be used as the aqueous medium, but a solvent miscible with water can also be used in combination. Further, the above-mentioned organic solvents used for the oil phase and having a Hansen solubility parameter of 19.5 or less can also be added, and preferably the added amount is near the saturation amount in water, as this will improve the emulsification or dispersion stability of the oil phase. Examples of such miscible solvents include alcohols (such as methanol, isopropanol and ethylene glycol), dimethylformamide, tetrahydrofuran, cellosolves (such as methyl cellosolve), and lower ketones (such as acetone and methyl ethyl ketone). The amount in which the aqueous medium is used is usually from 50 parts by mass to 2,000 parts by mass, and preferably from 100 parts by mass to 1,000 parts by mass, per 100 parts by mass of a toner composition. If the amount is less than 50 parts by mass, the toner composition will not be dispersed well, and toner particles of the specified size will not be obtained. Use of the amount more than 2,000 parts by mass is economically disadvantageous.

### (Inorganic Dispersing Agent and Organic Resin Fine Particle)

A solution or dispersion of the toner composition is preferably dispersed in the aqueous medium in the presence of an inorganic dispersing agent or organic resin fine particles. Using a dispersing agent is preferable because the resulting particles will have a sharp particle size distribution and good dispersion stability. Examples of inorganic dispersing agents include tricalcium phosphate, calcium carbonate, titanium oxide, colloidal silica, and hydroxyapatite. The resin that forms the organic resin fine particles can be any resin with which an aqueous dispersion can be formed, and may be either a thermoplastic resin or a thermosetting resin. Examples include vinyl resin, polyurethane resin, epoxy resin, polyester resin, polyamide resin, polyimide resin, silicon resin, phenol resin, melamine resin, urea resin, aniline resin, ionomer resin, and polycarbonate resin. Two or more of these resins can also be used. Of these, it is preferable to use a vinyl resin, a polyurethane resin, a epoxy resin, a polyester resin, or a combination of these because these resins will readily form aqueous dispersions of fine, spherical resin particles.

### (Method of Dispersing Organic Resin Fine Particles in Aqueous Medium)

There are no particular restrictions on the method for making the organic resin into an aqueous dispersion of organic resin fine particles, but the following (a) to (h) are examples.

(a) When the resin is a vinyl resin, an aqueous dispersion of resin fine particles is directly formed by polymerization reaction (such as suspension polymerization, emulsion polymerization, seed polymerization, or dispersion polymerization), using monomers as the starting raw material.

(b) When the resin is a polyaddition resin or a polycondensation resin such as a polyester resin, polyurethane resin, or epoxy resin, a precursor (such as a monomer or oligomer) or a solvent solution of the precursor is dispersed in an aqueous medium in the presence of a suitable dispersing agent, after which this product is heated or a curing agent is added to cure the material and manufacture an aqueous dispersion of resin fine particles.

(c) When the resin is a polyaddition resin or a polycondensation resin such as a polyester resin, polyurethane resin, or epoxy resin, a suitable emulsifying agent is dissolved in a precursor (such as a monomer or oligomer) or a solvent solution of the precursor (preferably in liquid form; may be liquefied by heating), after which water is added to perform phase-inversion emulsification.

(d) A resin produced by a polymerization reaction (such as addition polymerization, ring cleavage polymerization, polyaddition, addition condensation, condensation polymerization, or any other such polymerization reaction format) is pulverized using a mechanical rotational pulverizer or a jet pulverizer, and then classified, to obtain resin fine particles, after which these are dispersed in water in the presence of a suitable dispersing agent.

(e) A resin formed by a polymerization reaction (such as addition polymerization, ring cleavage polymerization, polyaddition, addition condensation, condensation polymerization, or any other such polymerization reaction format) is dissolved in a solvent, and then the resin solution is sprayed as a mist to obtain resin fine particles, after which these are dispersed in water in the presence of a suitable dispersing agent.

(f) A resin formed by a polymerization reaction (such as addition polymerization, ring cleavage polymerization, polyaddition, addition condensation, condensation polymerization, or any other such polymerization reaction format) is dissolved in a solvent to prepare a resin solution, to which a solvent is added, or a resin solution that has been heated and dissolved in a solvent is cooled, thereby precipitating resin fine particles, and then the solvent is removed so that resin fine particles are obtained, after which these are dispersed in water in the

(g) A resin formed by a polymerization reaction (such as addition polymerization, ring cleavage polymerization, polyaddition, addition condensation, condensation polymerization, or any other such polymerization reaction format) is dissolved in a solvent, and then the resin solution is dispersed in an aqueous medium in the presence of a suitable dispersing agent, and this dispersion is heated, subjected to reduced pressure, etc., to remove the solvent.

(h) A resin formed by a polymerization reaction (such as addition polymerization, ring cleavage polymerization, polyaddition, addition condensation, condensation polymerization, or any other such polymerization reaction format) is dissolved in a solvent to prepare a resin solution, and then a suitable emulsifying agent is dissolved in the resin solution, after which water is added and phase-inversion emulsification is performed.

### (Surfactant)

A surfactant or the like can be used as needed to emulsify or disperse, in an aqueous medium, the oil phase which contains the toner composition. Examples of surfactants include anionic surfactants such as alkylbenzenesulfonates, α-olefin sulfonates, and phosphoric acid esters; cationic surfactants such as amine salts (such as alkyl amine salts, aminoalcohol fatty acid derivatives, polyamine fatty acid derivatives, and imidazoline), and quaternary ammonium salts (such as alkyltrimethyl ammonium salts, dialkyldimethyl ammonium salts, alkyldimethyl benzyl ammonium salts, pyridinium salts, alkyl isoquinolinium salts, and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine, and N-alkyl-N,N-dimethylammonium betaine.

By using a surfactant having a fluoroalkyl group, the effect of the surfactant can be achieved by using on a small amount thereof. Examples of anionic surfactants having a fluoroalkyl group and that can be used favorably include fluoroalkyl carboxylic acids having from 2 to 10 carbon atoms and metal salts thereof, disodium perfluorooctanesulfonyl glutamate, sodium 3-[ω-fluoroalkanoyl (C₆-C₁₁)oxy]-1-alkyl(C₃-C₄) sulfonate, sodium 3-[ω-fluoroalkanoyl(C₆-C₈)—N-ethylamino]-1-propanesulfonate, fluoroalkyl(C₁₁-C₂₀) carboxylic acid and metal salts thereof, perfluoroalkyl(C₇-C₁₃) carboxylic acid and metal salts thereof, perfluoroalkyl(C₄-C₁₂)sulfonic acid and metal salts thereof, perfluorooctanesulfonic acid diethanol amide, N-propyl-N-(2-hydroxyethyl)perfluorooctanesulfone amide, perfluoroalkyl(C₆-C₁₀)sulfonamide propyl trimethyl ammonium salts, perfluoroalkyl(C₆-C₁₀)—N-ethylsulfonylglycine salts, and monoperfluoroalkyl(C₆-C₁₆)ethyl phosphates. Examples of cationic surfactants include primary, secondary and tertiary amines having a fluoroalkyl group, aliphatic quaternary ammonium salts such as perfluoroalkyl(C₆-C₁₀)sulfonamide propyl trimethyl ammonium salts, benzalkonium salts, benzetonium chloride, pyridinium salts, and imidazolinium salts.

### (Protective Colloid)

It is also possible to stabilize dispersion droplets with a polymeric protective colloid. Examples include homopolymers and copolymers of monomers such as acids (such as acrylic acid, methacrylic acid, α-cyanoacrylic acid, α-cyanomethacrylic acid, itaconic acid, crotonic acid, fumaric acid, maleic acid, and maleic anhydride), (meth)acrylic monomers having a hydroxyl group (such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerol monoacrylic acid esters, glycerol monomethacrylic acid esters, N-methylolacrylamide, and N-methylolmethacrylamide), vinyl alcohol and ethers of vinyl alcohol (such as vinyl methyl ether, vinyl ethyl ether, and vinyl propyl ether), esters of vinyl alcohol and a compound having a carboxyl group (such as vinyl acetate, vinyl propionate, and vinyl butyrate), acrylamide, methacrylamide, diacetoneacrylamide, and methylol compounds thereof, acid chlorides (such as acrylic acid chloride and methacrylic acid chloride), and monomers having a nitrogen atom or a hetero ring (such as vinyl pyridine, vinyl pyrrolidone, vinyl imidazole, and ethyleneimine); as well as compounds based on polyoxyethylene compounds (such as polyoxyethylene, polyoxypropylene, polyoxyethylene alkylamines, polyoxypropylene alkylamines, polyoxyethylene alkylamides, polyoxypropylene alkylamides, polyoxyethylene nonylphenyl ethers, polyoxyethylene lauryl phenyl ethers, polyoxyethylene stearyl phenyl esters, and polyoxyethylene nonylphenyl esters), and cellulose compounds (such as methyl cellulose, hydroxyethyl cellulose, and hydroxypropyl cellulose). When compounds such as calcium phosphate that are soluble in acids and alkalies are used as a dispersion stabilizer, the calcium phosphate is removed from the fine particles by a method such as dissolving the calcium phosphate with an acid such as hydrochloric acid and then washing with water. The calcium phosphate can also be removed by enzymatically decomposing it. When a dispersing agent is used, the dispersing agent can be left on the toner particle surface, but it is preferably washed away after the elongation and/or crosslinking reaction, as this will improve the charging of the toner.

### (Dispersion Method)

There are no particular restrictions on the dispersion method, and any known equipment can be used, such as low-shear equipment, high-shear equipment, friction equipment, high-pressure jet equipment, and ultrasonic equipment. To adjust the particle size of the dispersion to between 2 μm and 20 μm, high-shear equipment is preferable. When high-shear equipment is used, there are no particular restrictions on the rotational speed, but it is usually from 1,000 rpm to 30,000 rpm, and preferably from 5,000 rpm to 20,000 rpm. The temperature during dispersion is usually from 0° C. to 150° C. (under pressure), and preferably from 20° C. to 80° C.

### (Solvent Removal)

In order to remove the organic solvent from the emulsion thus obtained, a known method can be employed in which the temperature of the entire system is gradually raised to completely evaporate off the organic solvent from the droplets.

<Elongation and/or Crosslinking Reaction>

When a modified polyester resin having an isocyanate group at the terminal and an amine capable of reacting with the isocyanate group are added in order to introduce an urea-modified polyester resin, the amine may be mixed in an oil phase before the toner composition is dispersed in an aqueous medium, or alternatively the amine may be added in the aqueous medium. The time required for completion of the reaction depends on the reactivity of the structure of the isocyanate group of the polyester prepolymer and the amine added. The time is usually 1 minute to 40 hours, preferably 1 hour to 24 hours. A reaction temperature is usually 0° C. to 150° C., preferably 20° C. to 98° C. The reaction may be conducted before the above-mentioned process of particle binding or during the process or after completion of the process. If necessary, a known catalyst may be used for the reaction.

### <Washing and Drying Process>

A known method may be used for washing and drying the toner particles dispersed in an aqueous medium. Specifically, after carrying out a solid-liquid separation using a centrifuge and a filter press, the resultant toner cake is re-dispersed in ion-exchange water having a temperature of room temperature to about 40° C., and then if necessary, pH of the resultant dispersion liquid is regulated by an acid or an alkali, and subsequently the pH regulated dispersion liquid is subjected to solid-liquid separation again. After repeating the process a few times to remove impurities, surfactants and the like, the resultant product was dried using a flash dryer, recirculation dryer, reduced-pressure dryer, vibrating fluid dryer, or the like, to thereby yield the toner particles. Fine particle components of the toner may be removed by a centrifuge. A particle distribution of the toner may be adjusted to a desired distribution using a known classification machine after drying.

A toner can be obtained by performing the following processes to the coloring particles prepared by pulverizing and ester elongation processes.

### <Heating Process>

A heating process is preferably interposed in the above-mentioned washing and drying process. When the toner particles is re-dispersed at least after the first solid-liquid separation, it is preferable to heat the toner particles to or over the glass transition temperature of the toner. A surfactant may be added for dispersing a toner during the heating.

If the heating is carried out after the drying process, in order for the toner to sufficiently disperse in the aqueous medium, it is preferable to add a surfactant to the medium.

By the process, the low molecular components exposed on the surface of the toner melt and move into the aqueous medium. The temperature for the heating have to be or over the glass transition temperature, but care should be made to use too high temperature because the toner particles tend to agglomerate each other under such a high temperature condition. Heating time is preferably one hour to 24 hours, more preferably 8 hours to 16 hours. If the heating time is shorter than one hour, the low molecular weight components do not sufficiently melt. It is no need to heat more than 24 hours because an amount of melted low molecular weight components is nearly saturated at 24 hours.

Thereafter, if needed, a washing and solid-liquid separation may be carried out, followed by drying, to finally obtain the toner particles.

### <External Addition>

The dried toner powder thus obtained is mixed with other particles, such as charge control fine particles or fluidizer fine particles, and the mixed powder may be subjected to mechanical impact to fix and fuse the particles at the surface, in order to prevent the other particles from falling off the surface of the composite particles thus obtained. Specific ways to accomplish this include a method in which a mixture is subjected to an impact force by blades rotating at high speed, and a method in which a mixture is put into a high-speed gas flow and accelerated, so that the particles collide with each other, or composite particles collide with a collision plate. Examples of the apparatus used for this include a HENSCHEL MIXER (produced by Mitsui Mining Co., Ltd.), a SUPER MIXER (produced by Kawata Mfg. Co., Ltd.) an ONG MILL (produced by Hosokawa Micron), a modified I MILL (produced by Nippon Pneumatic) in which a lowered pulverizing air pressure is used, a HYBRIDIZATION SYSTEM (produced by Nara Machine), a KRYPTON SYSTEM (produced by Kawasaki Heavy Industries), and an automatic mortars.

The toner of the present invention may be used as a nonmagnetic one-component developer, or as a two-component developer containing a suitable external agent and a suitable carrier.

### <Toner-Filled Container>

A toner-filled container includes a container which is filled with the toner and the developer.

The container is not particularly limited, and can be selected from known containers as appropriate. For example, it is preferable to use a container having a toner container body and a cap.

The toner container body is not limited in terms of size, shape, structure and material, and can be selected appropriately according to the purpose. As for the shape, preferable is a cylindrical shape or the like is preferable. More preferable is a cylinder in which spiral concavity and convexity are formed on the surface of the inner circumference, and the toner, the contents of the cylinder, is movable to an outlet side by rotating, and part or whole of the spiral portion has a function of bellows.

A material for the toner container body is not particularly limited, but preferably is that having high dimensional accuracy, such as a resin. Examples of the resin include polyester resin, polyethylene resin, polypropylene resin, polystyrene resin, polyvinyl chloride resin, polyacrylic resin, polycarbonate resin, ABS resin, and polyacetal resin.

The toner-filled container is easy to storage and convey, has excellent in handling property, and can be properly mounted detachably on the process cartridge, the image forming apparatus, and the like as described below to supply the toner.

### <Image Forming Apparatus>

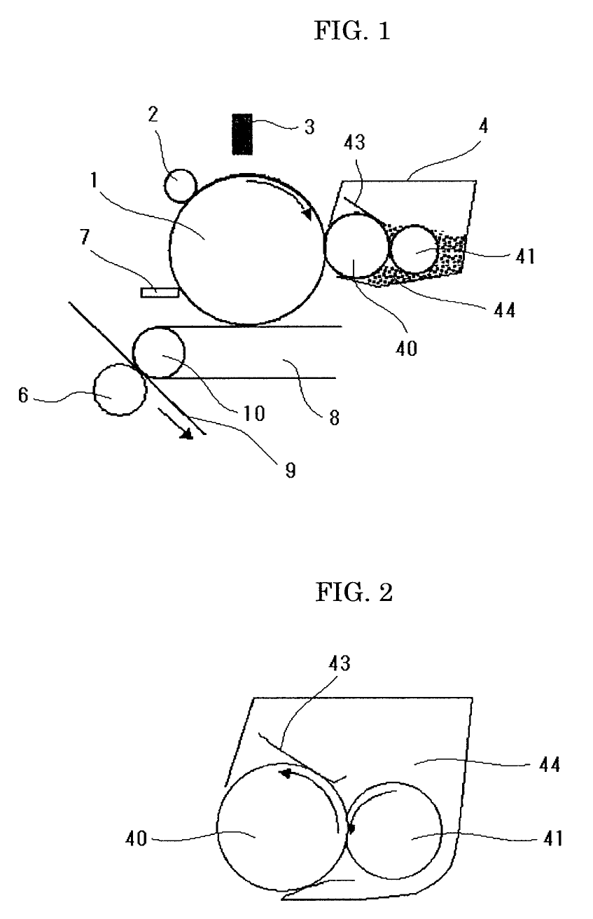

FIG. 1 is a schematic diagram illustrating the image forming apparatus of the present invention. The latent electrostatic image bearing member 1 is charged with the charging device 2, and a latent image is formed by the exposure device 3. Since a bias voltage is impressed between developing roller 40 and the latent electrostatic image bearing member 1, the formed latent image is developed and visualized on the portion contacting with the developing agent 44 which is supplied by the supply roller 41 and thinned by the regulating blade 43 on developing roller 40. The developing agent 44 attached to the latent image is once transferred onto the intermediate transfer material 8, and then transferred developing agent is further transferred to the recording material 9 such as paper, and fixed on the recording medium 9 by a fixation device. Meanwhile, a slight amount of the developing agent on the latent image remains on the latent electrostatic image bearing member even after the intermediate transfer material 8 passes through the latent electrostatic image bearing member. The developing agent remaining on the carrier is recovered by the blade-shaped cleaning member 7 and is discarded.

In FIG. 1, “4” is a developing device, “6” is a transfer roller, and “10” is a supporting roller.

Next, the developing portion will be explained.

FIG. 2 is a schematic diagram of the developing device (process cartridge). The developing agent (toner) 44 in the toner supplying portion inside the container is carried to the nip portion of developing roller 40 under stirring with supply roller 41. An amount of the toner on the developing roller 40 is regulated with the regulating blade 43, and a thin layer of the toner is formed on the developing roller. Then the toner is controlled to have an appropriate electric charge by the friction arising between the nip portion of the supply roller and the developing roller and between the regulating member and the developing roller. In a cleanerless process, to recover the transferred toner, chargeability tends to be far off from a proper value. Thus the toner recovered by the developing roller can be sufficiently removed by the scraping with the supply roller.

### <Process Cartridge>

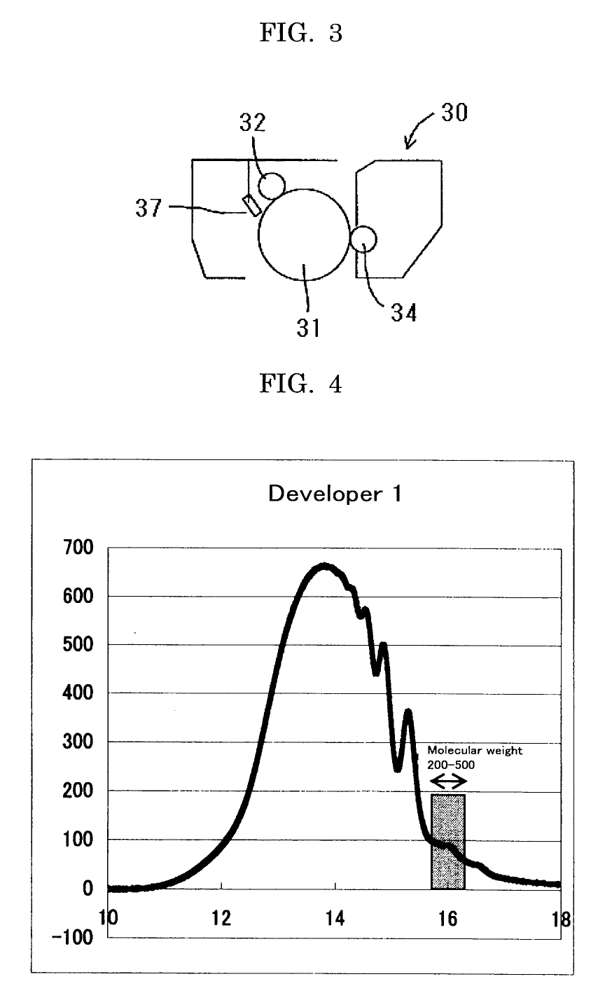

The developer of the present invention can be used in image forming apparatus equipped with the process cartridge shown in FIG. 3, for example.

With the present invention, a plurality of constituent elements, such as a latent electrostatic image bearing member, an electrostatic latent image charging unit, a developing unit are integrally joined together as a process cartridge, and this process cartridge can be detachably installed in the main body of a copier, printer, or other such image forming apparatus.

The process cartridge 30 shown in FIG. 3 has a latent electrostatic image bearing member 31, an electrostatic latent image charging unit 32, a developing unit 34, and a cleaning unit 37. In the operation of this process cartridge, the latent electrostatic image bearing member 31 is rotationally driven at a specific peripheral speed. In the course of rotating, the latent electrostatic image bearing member 31 receives from the charging unit 32 a uniform, positive or negative electrical charge of a specific potential around its periphery, and then receives image exposure light from an image exposing unit, such as slit exposure or laser beam scanning exposure, and in this way an electrostatic latent image is steadily formed on the periphery of the latent electrostatic image bearing member 31. The electrostatic latent image thus formed is then developed with a toner from the developing unit 34, and the developed toner image is steadily transferred by a transfer unit onto a transfer material that is fed from a paper supplier to in between the latent electrostatic image bearing member 31 and the transfer unit, in synchronization with the rotation of the latent electrostatic image bearing member 31.

The transfer material that has received the transferred image is separated from the surface of the latent electrostatic image bearing member 31, introduced into an image fixing unit, where the image is fixed, and this product is printed out from the device as a copy or a print. The surface of the latent electrostatic image bearing member 31 after the image transfer is cleaned by the cleaning unit 37 so as to remove the toner that remains after the transfer, and is electrically neutralized and repeatedly used for image formation.

Analysis of the Toner was Performed as Follows:

### <Measurement Method>

### (Glass Transition Temperature)

The glass transition temperature of a sample toner can be measured using, for example, a differential scanning calorimeter (e.g., DSC-6220R, produced by Seiko Instruments Inc.) in the following manner. The sample is heated from room temperature to 150° C. at a temperature rise rate of 10° C./min, allowed to stand for 10 min at 150° C., cooled to room temperature, allowed to stand for 10 min, and again heated to 150° C. at a temperature rise rate of 10° C./min. The glass transition temperature can be determined from the point where the baseline which is under the glass transition temperature crosses the tangential line of the curved portion indicating the glass transition.

### (Particle Size)

Next, the method of measuring a particle size distribution of the toner particles will now be described.

The particle size distribution of a toner can be measured using a COULTER COUNTER TA-II or COULTER MULTISIZER II (both produced by Beckman Coulter Inc.). The measurement method will now be described.

First, 0.1 mL to 5 mL of a surfactant (preferably an alkylbenzene sulfonate) is added as a dispersing agent to 100 mL to 150 mL of an electrolyte aqueous solution. Here, the electrolyte is an approximately 1% NaCl aqueous solution prepared using extra-pure sodium chloride, such as ISOTON-II (produced by Beckman Coulter Inc.). Then, 2 mg to 20 mg (as solids) of measurement sample is added. The same is suspended in the electrolyte and dispersed with an ultrasonic disperser for about 1 minute to 3 minutes, the volume of a toner and the number of toner particles are measured with the above measurement device at an aperture of 100 μm, and the volume and number distributions are calculated. The volume average particle size (Dv) and the number average particle size (Dp) can be determined from the resulting distributions.

Thirteen channels are used, as follows: from 2.00 μm to less than 2.52 μm, from 2.52 μm to less than 3.17 μm, from 3.17 μm to less than 4.00 μm, from 4.00 μm to less than 5.04 μm, from 5.04 μm to less than 6.35 μm, from 6.35 μm to less than 8.00 μm, from 8.00 μm to less than 10.08 μm, from 10.08 μm to less than 12.70 μm, from 12.70 μm to less than 16.00 μm, from 16.00 μm to less than 20.20 μm, from 20.20 μm to less than 25.40 μm, from 25.40 μm to less than 32.00 μm, and from 32.00 μm to less than 40.30 μm. Therefore, particles having a size of from 2.00 μm to less than 40.30 μm can be measured.

### (GPC Analysis)

### (1) Molecular Weight

Molecular weights of the toner and polyester resins used were measured by gel permeation chromatography (GPC) under the following conditions:
device: HLC-8220GPC (produced by Tosoh Corp.)
column: TSK GEL SUPER HZM-M×3
temperature: 40° C.
solvent: THF (tetrahydrofuran)
flow rate: 0.35 ml/min
sample: 0.01 ml of a sample having a concentration of 0.05% to 0.6% is poured.
detector: UV (230 nm)

Based on the molecular weight distribution of the toner resin measured under the above conditions, and using the molecular weight correction curve made by a monodisperse polystyrene standard sample, a number-average molecular weight (Mn) and a weight-average molecular weight (Mw) were calculated. As Monodisperse polystyrene standard samples, ten samples in the range of 5.8×100 to 7.5×1,000,000 were used.

### (2) Ratio of Peak Area

Using the obtained chromatograph, the whole peak area and peak area for molecular weight 200 to 500 was determined and the ratio of the peak area was calculated.

Ratio (%) of peak area of molecular weight 200 to 500=(peak area of molecular weight 200 to 500/whole peak area)×100

### EXAMPLES

The present invention will now be described in further detail by giving Examples and Comparative Examples, but the present invention is not limited to the Examples. The “parts” means “parts by mass.”

### <Synthesis of Polyesters>

### (Polyester 1)

In a reaction vessel equipped with a condenser tube, a stirrer and a nitrogen inlet tube, 553 parts of a 2 mol ethylene oxide adduct of bisphenol A, 196 parts of a 2 mol propylene oxide adduct of bisphenol A, 220 parts of terephthalic acid, 45 parts of adipic acid, and 2 parts of dibutyltinoxide were placed and reacted for 8 hours at 230° C. under normal pressure, and further reacted for 5 hours under a reduced pressure of 10 mmHg to 15 mmHg, after which 46 parts of trimellitic anhydride was added, and the mixture was reacted for 2 hours at 180° C. under normal pressure to obtain “polyester 1.” Polyester 1 had a number-average molecular weight of 2,200, a weight-average molecular weight of 5,600, a Tg of 43° C., and an acid value of 13.

### (Polyester 2)

In a reaction vessel equipped with a condenser tube, a stirrer and a nitrogen inlet tube, 519 parts of 2 mol ethylene oxide adduct of bisphenol A, 233 parts of 2 mol propylene oxide adduct of bisphenol A, 127 parts of terephthalic acid, 137 parts of isophthalic acid, and 2 parts of dibutyltinoxide were placed and reacted for 5 hours at 230° C. under normal pressure, and further reacted for 4 hours under a reduced pressure of 10 mmHg to 15 mmHg, after which 51 parts of trimellitic anhydride was added to the reaction vessel, and the mixture was reacted for 2 hours at 180° C. under normal pressure to obtain “polyester 2.” Polyester 2 had a number-average molecular weight of 1,700, a weight-average molecular weight of 4,400, a Tg of 40° C.

### (Polyester 3)

In a reaction vessel equipped with a condenser tube, a stirrer and a nitrogen inlet tube, 290 g of 2 mol ethylene oxide adduct of bisphenol A, 1230 g of a 2 mol propylene oxide adduct of bisphenol A, 310 g of terephthalic acid, 250 g of isododecenyl succinic anhydride, 180 g of 1,2,4-benzenetricarboxylic anhydride, and 7 g of dibutyltinoxide as an esterification catalyst were placed and the mixture was heated to 230° C., followed by polycondensation reaction under normal pressure.

A polymerization degree was followed by the softening point measured using a constant load extrusion capillary rheometer, and the reaction was terminated when the softening point was reached to the desired softening point to obtain “polyester 3.” Polyester 3 had a number-average molecular weight of 2,600, a weight-average molecular weight of 32,000, and a glass transition temperature of 62° C.

### <Synthesis of Prepolymer>

To a reaction vessel equipped with a condenser tube, a stirrer and a nitrogen inlet tube, 682 parts of a 2 mol ethylene oxide adduct of bisphenol A, 81 parts of a 2 mol propylene oxide adduct of bisphenol A, 283 parts of terephthalic acid, 22 parts of trimellitic anhydride, and 2 parts of dibutyltin oxide were placed and reacted for 8 hours at 230° C. under normal pressure, and further reacted for 5 hours under a reduced pressure of 10 mmHg to 15 mmHg to obtain “intermediate polyester 1.” Intermediate polyester 1 had a number-average molecular weight of 2,100, a weight-average molecular weight of 9,500, a Tg of 55° C., an acid value of 0.5, and a hydroxyl value of 49.

Next, in a reaction vessel equipped with a condenser tube, a stirrer and a nitrogen inlet tube, 411 parts of intermediate polyester 1, 89 parts of isophorone diisocyanate, and 500 parts of ethyl acetate were placed and reacted for 5 hours at 100° C. to obtain “prepolymer 1.” Prepolymer 1 had a free isocyanate content of 1.53% by mass.

### <Synthesis of Masterbatch>

In a HENSCHEL MIXER, 40 parts of Carbon black (REGAL 400R, produced by Cabot Corporation), 60 parts of a binder resin (RS-801 polyester resin, produced by Sanyo Chemical Industries, Ltd.; acid value: 10, Mw: 20,000, Tg: 64° C.), and 30 parts of water were mixed to obtain a mixture in which a pigment aggregate was impregnated with water. The resultant mixture was kneaded for 45 minutes in a two-roll kneader with the roll surface temperature set at 130° C., and the kneaded product was pulverized to a size of 1 mmφ with a pulverizer, thereby obtaining “master batch 1.”

### Example 1

### Production of Pigment/Wax Dispersion Liquid (Oil Phase)

In a vessel equipped with a stirrer and a thermometer, 378 parts of polyester 1, 120 parts of paraffin wax (HNP9), and 1,450 parts of ethyl acetate were placed, and the mixture was heated to 80° C. under stirring, the temperature was held at 80° C. for 5 hours, and then the resultant mixture was cooled to 30° C. in 1 hour. Then, 500 parts of master batch 1 and 500 parts of ethyl acetate were placed in the vessel and mixed for 1 hour to obtain “raw material solution 1.”

To the vessel, 1,500 parts of raw material solution 1 was transferred, and the carbon black and the wax were dispersed by passing the dispersion liquid through a bead mill (ULTRAVISCOMILL, produced by Imex Co., Ltd.) filled to 80% by volume with zirconia beads having a diameter of 0.5 mm, for three passes, at a liquid feed rate of 1 kg/hr and a disk peripheral speed of 6 m/sec. Then, 655 parts of a 65% ethyl acetate solution of polyester 1 was added, and the resultant mixture was passed one time through bead mill under the above conditions to obtain “pigment-wax dispersion liquid 1.” Ethyl acetate was added to the pigment-wax dispersion liquid 1 so as to have a solid content of 50% (130° C., 30 minutes).

### <Preparation of Aqueous Phase>

In 953 parts of ion exchange water, 88 parts of a 25% by mass aqueous dispersion liquid of organic resin fine particles (a copolymer of styrene-methacrylic acid-butyl acrylate-sodium salt of sulfuric acid ester of ethylene oxide adduct of methacrylic acid) used as a dispersion stabilizer, 90 parts of a 48.5% aqueous solution of sodium dodecyldiphenyl ether disulfonate (ELEMINOL MON-7, produced by Sanyo Chemical Industries Ltd.), and 113 parts of ethyl acetate were mixed under stirring to obtain a milky white liquid. This was termed “aqueous phase 1.”

### <Emulsifying Step>

In a vessel, 967 parts of pigment/wax dispersion liquid 1, 2% (a toner solid content basis) of a modified layered inorganic mineral (CLAYTON APA, produced by Southern Clay Products, Inc.), and 6 parts of isophorone diamine as an amine were placed and mixed for 1 minute at 5,000 rpm with a TK HOMOMIXER (produced by Primix Corp.), after which 137 parts of prepolymer 1 was added and mixed for 1 minute at 5,000 rpm with a TK HOMOMIXER, and 1,200 parts of water phase 1 was added and mixed for 20 minutes at 8,000 to 13,000 rpm with a TK HOMOMIXER to obtain “emulsified slurry 1”.

### <Solvent Removal>

Emulsified slurry 1 was poured into a vessel equipped with a stirrer and a thermometer, and solvent removal was performed for 8 hours at 30° C. to obtain “dispersion slurry 1.”

### <Washing and Drying>

One-hundred parts of dispersion slurry 1 was filtered under reduced pressure, and then the following steps were carried out.

(1) To the filter cake, 100 parts of ion exchange water was added and mixed with a TK HOMOMIXER (for 10 minutes at 12,000 rpm, and the mixture was then filtered.

(2) 900 parts of ion exchange water was added to the filter cake obtained in (1) and ultrasonic vibration was applied and the components were mixed with a TK HOMOMIXER (for 30 minutes at 12,000 rpm), and then the mixture was filtered under reduced pressure. This operation was repeated so that the electrical conductivity of the reslurry was 10 μC/cm or less.

(3) 200 parts of ion exchange water was added to the reslurry obtained in (2), and ultrasonic vibration was applied and the components were mixed with a TK HOMOMIXER (for 30 minutes at 12,000 rpm). To the mixture, 90 parts of a 48.5% aqueous solution of sodium dodecyldiphenylether disulfonate (ELEMINOL MON-7, produced by Sanyo Chemical Products, Inc.) was added and mixed with a TK HOMOMIXER (for 5 minutes at 2,500 rpm). The resultant mixture was transferred to a reaction vessel, and stirred for 16 hours at 60° C. to obtain “heated slurry 1.”

One-hundred parts of heated slurry 1 was filtered under reduced pressure, and then the following steps were carried out.

(4) 100 parts of ion exchange water was added to the filter cake, and the components were mixed with a TK HOMOMIXER (for 10 minutes at 12,000 rpm), and then the mixture was filtered.

(5) 900 parts of ion exchange water was added to the filter cake obtained in (4), and ultrasonic vibration was applied and the components were mixed with a TK HOMOMIXER (for 30 minutes at 12,000 rpm), and then the mixture was filtered under reduced pressure. This operation was repeated so that the electrical conductivity of the reslurry was 10 μC/cm or less.

(6) 10% hydrochloric acid was added to adjust the pH of reslurry obtained in (5) to 4. This product was then stirred for 30 minutes with a three-one-motor, and then filtered.

(7) 100 parts of ion exchange water was added to the filter cake obtained in (6), and the components were mixed with a TK HOMOMIXER (for 10 minutes at 12,000 rpm), and then the mixture was filtered. This operation was repeated so that the electrical conductivity of the reslurry was 10 μC/cm or less to thereby obtain “filter cake 1.”

Filter cake 1 was dried for 48 hours at 45° C. in a circular air drier and then sieved through a 75 μm mesh sieve to obtain “toner base 1.” Next, 1 part of hydrophobic silica R972 (produced by Nippon aerosil was added to 100 parts of the toner base and mixed in a HENSCHEL mixer to obtain “toner 1” of the present invention.

Toner 1 has a Tg of 54° C., a volume average particle diameter (Dv) of 5.8 μm, a number average particle diameter (Dp) of 5.2 μm, Dv/Dp is 1.12, a weight average molecular weight (Mw) of the THF soluble components measured by GPC of 10982, and a peak area of low molecular components having a molecular weight of 200 to 500 of 1.5% based on the whole peak areas. The GPC chart of the obtained toner (developer 1) was depicted in FIG. 4.

The obtained developer was evaluated in the following manner.

### (Evaluation of Fixing and Separating)

A 36 mm-width solid band image (applied amount of 9 g/m²) was printed on the front edge in 3 mm of vertically fed A4-size sheet using the toner treated with the external additive (developer) by IPSIO CX2500 (produced by Ricoh Co., Ltd.) to prepare an unfixed image. The unfixed image was fixed with a fixing device mentioned below at the fixing temperature of every 10° C. in the range from 130° C. to 190° C. to obtain a range of separable/non-offset temperature. The temperature range was the range of fixing temperature in which a sheet could be separated well from a heating roller, no offset phenomenon occurred, and the image did not peel easily. A paper of 45 g/m², and short grain was vertically fed, which is disadvantageous for a separating ability. The peripheral speed of the fixing device was 120 mm/sec.

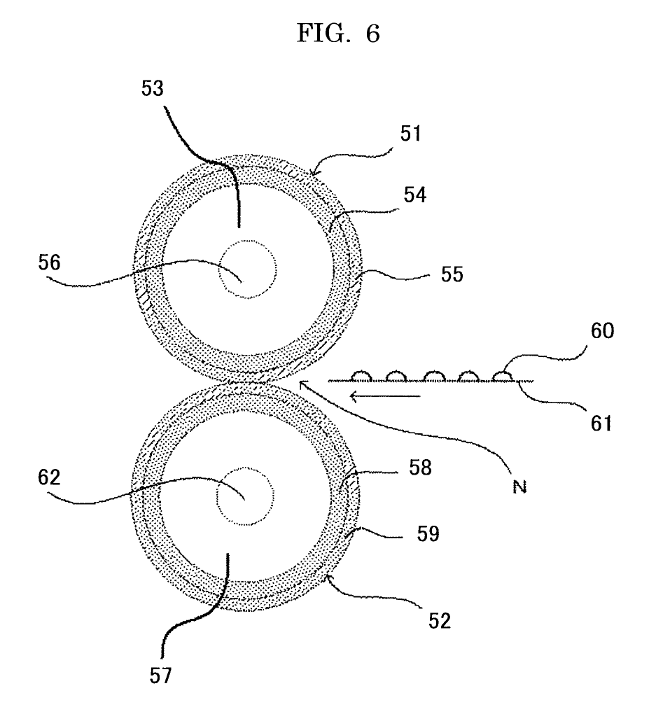

The fixing device is the one utilizing soft rollers each having a surface layer made of fluorine-based material, as depicted in FIG. 6. Specifically, the heating roller 51 has an outer diameter of 40 mm, in which a 1.5 mm-thick elastic layer 54 of a silicone rubber is disposed on an aluminum core 53, and a PFA (tetrafluoroethylene-perfluoroalkylvinyl ether copolymer) surface layer 55 is disposed on the elastic layer 54, and a heater 56 is equipped inside of the aluminum core 53. The pressurizing roller 52 has an outer diameter of 40 mm, in which a 1.5 mm-thick elastic layer 58 of a silicon rubber is disposed on an aluminum core 57, and a PFA surface layer 59 is disposed on the elastic layer. The aluminum core 57 has therein a heater 62. The paper 61 on which the unfixed image 60 is printed was passed through the fixing device. In FIG. 6, N is a nip.

### Evaluation Criteria are:

A: Separable/non-offset temperature range was 50° C. or more
B: Separable/non-offset temperature range was 40° C. or more and less than 50° C.
C: Separable/non-offset temperature range was 30° C. or more and less than 40° C.
D: Separable/non-offset temperature range was less than 30° C.

### (Evaluation of Fixing Strength)

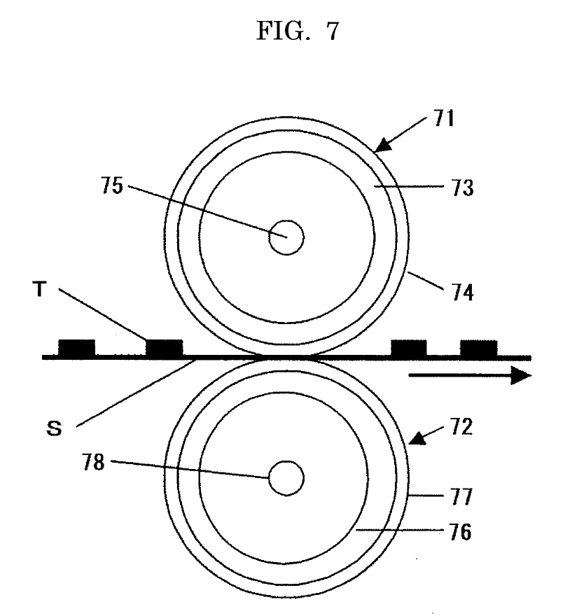

A fixing unit (contact pressure: 0.7×10⁵ Pa·s) as depicted in FIG. 7 was mounted in a copier IMAGIO MF6550 (produced by Ricoh Co., Ltd.), and the temperature of the heater was changed and an image was copied to obtain a fixed image. A mending tape (produced by 3M) was applied and adhered on the image after fixing, and a certain pressure was applied thereon, followed by peeling slowly. The image densities before the application of the tape, and after peeling the tape were measured by a Macbeth densitometer, and the fixing rate was calculated by the following formula.

Fixing rate (%)=the image density after peeling the tape/the image density before taping×100.

The temperature of the fixing roller was gradually cooled and the fixing temperature was determined as a temperature when the fixing rate became 80% or less. The result of the evaluation was ranked with the following 3 grades.

A: Fixing temperature of less than 130° C.

B: Fixing temperature of 130° C. or more to less than 150° C.

C: Fixing temperature of 150° C. or more

In FIG. 7, 71 is a fixing roller, 72 is pressurizing roller, 73 and 76 are metallic cylinders, 74 and 77 are offset-proof layers, 75 and 78 are heating lamps, T is a toner, and S is a fixing support.

### (Adherence Evaluation)

The obtained toner was placed in a process cartridge of a printer IPSIO CX2500 (produced by Ricoh Co., Ltd.), and the developing roller was revolved for 40 minutes at 400 rpm to test acceleration durability. After performing the acceleration durability test, the conveying surface of the developer roller was observed, and found that the conveying surface was homogeneous. Then, the regulating blade was removed from the printer, and the toner attached on the blade was blown off by an air gun. As a result, no adhered matter was found on the regulating blade, indicating that adherence on the regulating blade did not occur.

Evaluation Criteria are as Follows:

A: There was completely no adhered matter on the blade.

B: Although there was a slight adhered matter, it did not affect the printed image so that there was practically no problem.

C: There was an adhered matter which could be removed by a finger rub, and white striped noise appeared in the printed image, which was practically problematic.

D: There was an adhered matter which could not be removed by a finger rub, and white striped noise appeared in the printed image, which was practically problematic.

### Examples 2-5, Comparative Examples 1, 2

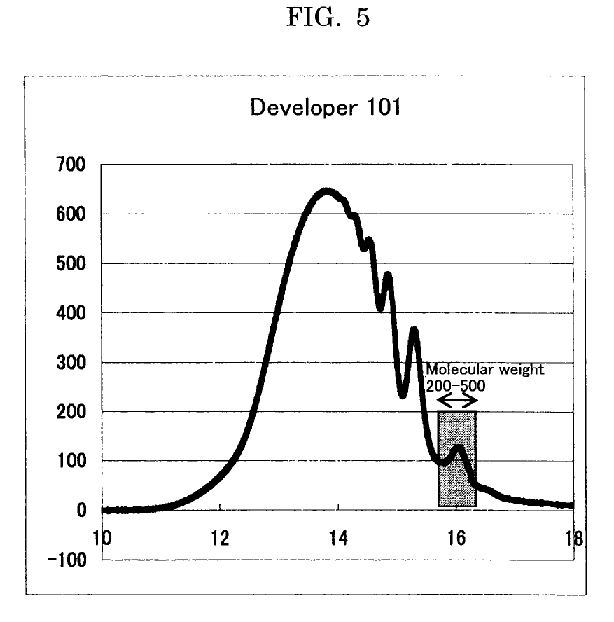

The toners for use in Examples 2-5 and Comparative Examples 1 and 2 were produced in the same manner as in Example 1, except that each heating temperature and stirring time in washing step (3) were changed to those shown in Table 1. Evaluation also was made in the same manner as in Example 1, and the results are shown in Table 1. In addition, the GPC chart for the toner (developer 101) produced by the method used in Comparative Example 1 was depicted in FIG. 5.

### Example 6

The toner for use in Example 6 was produced in the same manner as in Example 1, except that polyester 1 was changed to polyester 2, the amount of isophorone diamine and prepolymer 1 used in the emulsifying step were changed to 0.7 parts by mass and 16 parts by mass, respectively. Evaluation was carried out in the same way as in Example 1.

### Example 7, Comparative Examples 3-5

The toners for use in Example 7 and Comparative Examples 3-5 were produced in the same manner as in Example 6, except that heating temperature and stirring time for the washing step (3) were changed to those shown in Table 1. Evaluation was carried out in the same way as in Example 1. Results of the evaluation were also shown in Table 1.

### Example 8, Comparative Example 6

### Production of Toner Particles

### 1) Premixing

In a HENSCHEL mixer, 80 parts of polyester 1, 20 parts of polyester 3, 2.5 parts of HNP-9 (produced by Nippon Seiro Co., Ltd.) as a releasing agent, and a master batch containing 4 parts of C.I.

Pigment Red 57-1 were mixed thoroughly.

### 2) Kneading

Melt-kneading of the premix using a millstone kneader (korokudo mill) was conducted under the conditions as follows: feeding amount: 95 kg/h, a screw revolution: 85 rpm and controlled temperatures: 10° C. at a feeding portion (F), 125° C. at barrel portions (K1-K4), and 100° C. at vent portions (V) and dice portions (D). The obtained kneaded product was rolled with cooling press rollers to a thickness of 2 mm, and the pressed product was cooled down by cooling belts, and roughly pulverized by a feather mill.

### 3) Pulverizing, Classification and External Addition

Then, the roughly pulverized product was further pulverized to an average particle size of 9 μm to 11 μm using a mechanical pulverizer (KTM, produced by Kawasaki Heavy Industries, Ltd.), followed by pulverizing with a jet pulverizer (IDS, produced by Nippon Pneumatic Mfg. Co., Ltd.), removing rough particles. Fine particles were then classified using a rotar classifier (Duplex classifier, 100ATP, produced by Hosokawa Micron Corporation), whereby toner bases having a volume average particle diameter of 8.0 μm was yielded.

Half weight of the toner bases obtained was taken out, and mixed with hydrophobic silica R972 (produced by Nippon Aerosil) in a ratio 100 parts by mass of toner bases to 1 part by mass of hydrophobic silica R972 by using a HENSCHEL mixer, to thereby obtain the toner of Comparative Example 6. The toner had a Tg of 46° C., a volume average particle diameter (Dv) of 8.0 μm, a number average particle diameter (Dp) of 6.9 μm, the ratio Dv/Dp of 1.16, the weight average molecular weight (Mw) of THF-soluble components by a GPC measurement of 9922, the peak area of low molecular weight components having a molecular weight of 200 to 500 of 3.6% with respect to the whole peak areas.

To 100 parts by mass of the toner bases were added 250 parts by mass of ion exchange water and 50 parts by mass of a 48.5% aqueous solution of sodium dodecyldiphenylether disulfonate (ELEMINOL MON-7; produced by Sanyo Chemical Industries Ltd.) to obtain a slurry in which the toner bases were homogeneously dispersed. The slurry was put in a reaction vessel, heated to 60° C. and stirred for 16 hours, and filtered under reduced pressure. 100 parts of ion exchange water was added to the filter cake and mixed using a TK homomixer (at 12,000 rpm, for 10 minutes), followed by filtration.

To the resultant filter cake, 900 parts of ion exchange water was added and they were mixed using a TK homomixer under an ultrasonic vibration (at 12,000 rpm for 30 minutes), followed by filtration under reduced pressure. This process was repeated such that the electric conductivity of the reslurry liquid was 10 μC/cm or less.

Then, 10% aqueous hydrochloric acid was added to the reslurry liquid so that pH of the reslurry liquid was 4, and the pH controlled reslurry liquid was stirred for 30 minutes with a three-one motor, and was filtered.

To the resultant filter cake, 100 parts of ion exchange water was added and they were mixed using a TK homomixer (at 12,000 rpm for 10 minutes), followed by filtration. This process was repeated such that the electric conductivity of the reslurry liquid was 10° C./cm or less, to thereby obtain a filter cake.

The resultant filter cake was dried for 48 hours at 45° C. using an air-circulating drier, and the dried product was sieved by 75 μm mesh to obtain “toner base 1.” Then 100 parts of the toner base 1 was mixed with 1 part of hydrophobic silica R972 (produced by Nippon Aerosil) by using a HENSCHEL mixer to obtain the toner of Example 8. The toner had a Tg of 47° C., a volume average particle diameter (Dv) of 8.0 μm, a number average particle diameter (Dp) of 7.0 μm, the ratio Dv/Dp of 1.15, the weight average molecular weight (Mw) of THF-soluble components by a GPC measurement of 10565, the peak area of low molecular weight components having a molecular weight of 200 to 500 of 1.6% with respect to the whole peak areas. The obtained toner was evaluated in the same manner as in Example 1. Results are shown in Table 1.

### Comparative Example 7

The toner of Comparative Example 7 was obtained in the same manner as in Example 1, except that the amount of isophorone diamine and prepolymer 1 used in the emulsifying step were changed to 9 parts and 206 parts, respectively, and washing step (3) was not performed. Evaluation was carried out in the same manner as in Example 1. Results of the evaluation were also shown in Table 1.

TABLE 1

| | | | | | | | | Peak area | | | |
|---|---|---|---|---|---|---|---|---|---|---|---|
| | | | | | | | | of low | | | |
| | | | | | | | | molecular | | | |
| | | | Tg of | | | | | weight | | | |
| | Temp. | Stirring | toner | Particle size | | | | components | | | |
| | (° C.) | Time | (° C.) | Dv (μm) | Dp (μm) | Dv/Dp | Mw | (%) | Offset | Fixability | Adherence |
| Example 1 | 60 | 16 H | 54 | 5.8 | 5.2 | 1.12 | 10982 | 1.5 | A | B | A |
| Example 2 | 55 | 16 H | 52 | 5.9 | 5.3 | 1.11 | 10812 | 2.2 | A | B | A |
| Example 3 | 45 | 16 H | 51 | 6.0 | 5.3 | 1.13 | 10059 | 3.2 | A | B | B |
| Example 4 | 60 | 10 H | 55 | 5.9 | 5.3 | 1.11 | 10888 | 1.8 | A | B | A |
| Example 5 | 60 | 5 H | 50 | 6.0 | 5.3 | 1.13 | 10601 | 2.9 | A | B | B |
| Example 6 | 60 | 16 H | 53 | 5.4 | 4.7 | 1.15 | 6295 | 2.5 | A | A | A |
| Example 7 | 60 | 10 H | 49 | 5.5 | 4.8 | 1.15 | 5600 | 3.1 | B | A | B |
| Example 8 | 60 | 16 H | 47 | 8.0 | 7.0 | 1.15 | 10565 | 1.6 | B | A | A |
| Comp. Ex. 1 | No heat-stirring | | 52 | 6.2 | 5.4 | 1.15 | 9813 | 3.8 | A | A | D |
| Comp. Ex. 2 | 60 | 1 H | 52 | 6.1 | 5.3 | 1.15 | 9933 | 3.6 | B | A | D |
| Comp. Ex. 3 | No heat-stirring | | 48 | 5.6 | 4.8 | 1.17 | 4887 | 5.8 | D | A | D |
| Comp. Ex. 4 | Room | 16 H | 49 | 5.5 | 4.8 | 1.15 | 5028 | 4.5 | C | A | D |
| | temp. | | | | | | | | | | |
| Comp. Ex. 5 | 40 | 16 H | 51 | 5.4 | 4.8 | 1.13 | 5648 | 3.3 | B | A | C |

| | | | | | | | | | | |
|---|---|---|---|---|---|---|---|---|---|---|
| Comp. Ex. 6 | No heat-stirring | 46 | 8.0 | 6.9 | 1.16 | 9922 | 3.6 | B | A | D |
| Comp. Ex. 7 | No heat-stirring | 55 | 5.8 | 4.7 | 1.13 | 13200 | 1.8 | A | C | A |

What is claimed is:

1. A toner for developing a latent electrostatic image, comprising:
a colorant,
a binder resin, and
a releasing agent,
wherein molecular weight distribution of THF-soluble components of the toner measured by a GPC is in the range of Mw 4,000 to Mw 11,000, and a peak area of low molecular weight components having a molecular weight of 200 to 500 is 3.2% or less based on the whole peak area.

2. The toner for developing a latent electrostatic image according to claim 1, wherein the toner has a glass transition temperature of 40° C. or higher.

3. The toner for developing a latent electrostatic image according to claim 1, wherein the toner has a volume-average particle diameter of 4.5 μm to 8 μm.

4. The toner for developing a latent electrostatic image according to claim 1, wherein the releasing agent comprises at least one of a polyolefin wax, a long chain hydrocarbon, or a carbonyl group-containing wax.

5. The toner for developing a latent electrostatic image according to claim 1, which is obtainable by the process comprising:
dissolving or dispersing, at least, a polyester resin, a polymer having a portion reactive with a compound having an active hydrogen-containing group, an active hydrogen-containing compound, a releasing agent, and a colorant in an organic solvent to obtain a solution or dispersion liquid;
dispersing the solution or dispersion liquid into an aqueous solvent; and
subjecting the polymer having a portion reactive with a compound having an active hydrogen-containing group and the compound having an active hydrogen-containing group to a cross-linking reaction or an elongation reaction.

6. The toner for developing a latent electrostatic image according to claim 5, wherein, in the organic solvent, an inorganic mineral having a layered structure in which at least a part of the ions present between the layers are modified with organic ions is dissolved or dispersed.

7. The toner for developing a latent electrostatic image according to claim 5, wherein the polymer having a portion reactive with a compound having an active hydrogen-containing group is a modified polyester prepolymer having an isocyanate group at a terminal thereof, and the active hydrogen-containing compound is an amine.

8. The toner for developing a latent electrostatic image according to claim 1, wherein the toner is a toner for developing a non-magnetized one component.

9. An image forming device comprising:
a toner for developing a latent electrostatic image; and
a container main body in which the toner is housed,
wherein the toner comprises a colorant, a binder resin, and a releasing agent, wherein molecular weight distribution of THF-soluble components of the toner measured by a GPC is in the range of Mw 4,000 to Mw 11,000, and a peak area of low molecular weight components having a molecular weight of 200 to 500 is 3.2% or less based on the whole peak area.

10. A process cartridge comprising:
a latent image carrier configured to form a latent image thereon; and
a developing device configured to develop the latent image formed on the latent image carrier with a toner,
wherein the latent image carrier and the developing device are mounted as one body, and the process cartridge is detachably mounted to an image forming device, and
wherein the toner comprises a colorant, a binder resin, and a releasing agent, wherein molecular weight distribution of THF-soluble components of the toner measured by a GPC is in the range of Mw 4,000 to Mw 11,000, and a peak area of low molecular weight components having a molecular weight of 200 to 500 is 3.2% or less based on the whole peak area.
